(19) United States
(12) Patent Application Publication
(10) Pub. No.: US 2026/0131587 A1
(43) Pub. Date: May 14, 2026

(54) PRINT APPARATUS, CONTROL METHOD, AND NON-TRANSITORY COMPUTER-READABLE STORAGE MEDIUM

(71) Applicant: CANON KABUSHIKI KAISHA, Tokyo (JP)

(72) Inventors: YUKARI SUMIOKA, Kanagawa (JP); TAKUMI KANEKO, Tokyo (JP)

(21) Appl. No.: 19/322,875

(22) Filed: Sep. 9, 2025

(30) Foreign Application Priority Data
Sep. 10, 2024 (JP) 2024-156833

(51) Int. Cl. B41J 29/393; B41J 11/00; B41M 3/00; B41M 7/00

(52) U.S. Cl. CPC B41J 29/393; B41J 11/00222; B41J 11/00242; B41M 3/008; B41M 7/009

(57) ABSTRACT

A print apparatus comprises a print unit applying ink to a transparent print medium, a drying unit drying a print medium to which ink is applied, and a control unit. The control unit causes the print unit to print a first layer, causes the drying unit to dry the transparent print medium on which the first layer is printed, and causes the print unit to print a second layer that conceals the first layer on the first layer after the first layer has dried, controls printing based on one print mode determined from among a plurality of print modes including a first and a second print mode in which a concealment rate of the second layer is different from a concealment rate of the first print mode, and controls drying of the first layer based on a drying condition in accordance with the concealment rate of the determined print mode.

### BACKGROUND

### Field of the Technology

The present disclosure relates to a print apparatus, a control method, and a non-transitory computer-readable storage medium.

### Description of the Related Art

There is a known inkjet print apparatus that prints an image on a print medium by discharging ink from a print head to the print medium.

The inkjet print apparatus may print an image on a transparent print medium. In such a case, when an image is formed only with an ink layer of a color ink, the image is seen through from the opposite side of the print medium. Thus, the inkjet apparatus forms a concealment layer that suppresses transparency of the image by discharging a white ink or the like on the ink layer of the color ink.

Japanese Patent Laid-Open No. 2014-166762 discloses a method including a step of forming a first layer by discharging an image ink from a first discharge port group onto a print medium using a print head divided into the first discharge port group and a second discharge port group in a conveyance direction of the print medium, and a step of forming a concealment layer that is a second layer that conceals an image of the first layer by discharging a concealment ink that is a concealment material from the second discharge port group. In this method, an image is printed so as not to be seen when viewed from the opposite side of the print medium.

Here, in a case where an image and a concealment layer are layered on a print medium, when the concealment layer on the upper layer is printed before the image on the lower layer is dried, the ink of the upper layer is immersed in the image on the lower layer. By this, when viewed from the opposite side of the print medium, the image shows through, which deteriorates the quality of the image. Therefore, the concealment layer on the upper layer was printed after the image on the lower layer was sufficiently dried.

However, in the above-described technique, the first layer is uniformly dried regardless of the characteristics of each layer, and thus the first layer cannot be appropriately dried.

### SUMMARY

Therefore, the present disclosure provides a technique that can appropriately dry the first layer.

The present disclosure in its first aspect provides a print apparatus comprising: a print unit that applies ink to a transparent print medium; a drying unit that dries a print medium to which ink is applied by the print unit; and a control unit that controls the print unit and the drying unit, wherein the control unit causes the print unit to print a first layer, causes the drying unit to dry the transparent print medium on which the first layer is printed, and causes the print unit to print a second layer that conceals the first layer on the first layer after the first layer has dried, controls printing of the first layer and the second layer based on one print mode determined from among a plurality of print modes including a first print mode and a second print mode in which a concealment rate of the second layer is different from a concealment rate of the first print mode, and controls drying of the first layer based on a drying condition in accordance with the concealment rate of the determined print mode.

The present disclosure in its second aspect provides a control method comprising: printing by applying ink to a transparent print medium; drying a print medium to which ink is applied; and controlling a print unit and a drying unit, wherein the controlling comprises controlling printing a first layer, drying the transparent print medium on which the first layer is printed, and printing a second layer that conceals the first layer on the first layer after the first layer has dried, controlling printing of the first layer and the second layer based on one print mode determined from among a plurality of print modes including a first print mode and a second print mode in which a concealment rate of the second layer is different from a concealment rate of the first print mode, and controlling drying of the first layer based on a drying condition in accordance with the concealment rate of the determined print mode.

The present disclosure in its third aspect provides a non-transitory computer-readable storage medium storing a computer program for causing, when read and executed by a computer, the computer to: control printing by applying ink to a transparent print medium, and drying a print medium to which ink is applied; wherein in the controlling, the computer program causes the computer to: control printing a first layer, drying the transparent print medium on which the first layer is printed, and printing a second layer that conceals the first layer on the first layer after the first layer has dried, control printing of the first layer and the second layer based on one print mode determined from among a plurality of print modes including a first print mode and a second print mode in which a concealment rate of the second layer is different from a concealment rate of the first print mode, and control drying of the first layer based on a drying condition in accordance with the concealment rate of the determined print mode.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a perspective view of an external appearance of an inkjet print apparatus of an embodiment.

FIG. 2 is a side view illustrating an internal configuration of the inkjet print apparatus of the embodiment.

FIG. 3 is a schematic view of the configuration of a print head of the embodiment as observed from a nozzle surface.

FIG. 4 is a block diagram illustrating a control system of the inkjet print apparatus of the embodiment.

FIG. 5A is a view for describing multipass layering printing, and is a view describing a nozzle region 1 and a nozzle region 2.

FIG. 5B is a cross-sectional view describing a two-layer image.

FIG. 5C is a view describing three nozzle regions formed by dividing all nozzles of a nozzle rows 303K and 307W into three.

FIG. 5D is a cross-sectional view describing a three-layer image.

FIG. 6 is a view illustrating a mask pattern.

FIG. 7A is a view describing control of time in which a first layer is printed in the first embodiment.

FIG. 7B is a view describing control of time in which a first layer is printed in a second embodiment.

FIG. 7C is a view describing control of time in which a first layer is printed in a fourth embodiment.

FIG. 8 is view showing a flowchart of print data generation processing of the embodiment.

FIG. 9A is a view illustrating an example of a user interface (UI) for selecting a print medium.

FIG. 9B is a view illustrating an example of a UI for selecting a print condition of a print mode.

FIG. 10A is a view for describing a relationship between a drying condition of a first layer 1002 and an immersion amount of a second layer 1003.

FIG. 10B is a cross-sectional view of each layer for describing print states of the first layer and the second layer under a drying condition D1.

FIG. 10C is a cross-sectional view of each layer for describing print states of the first layer and the second layer under a drying condition D2.

FIG. 10D is a cross-sectional view of each layer for describing print states of the first layer and the second layer under a drying condition D3.

FIG. 11A is a view for describing a relationship between a drying condition in an OF configuration and an immersion phenomenon and show through.

FIG. 11B is a cross-sectional view describing print states of the first layer and the second layer under the drying condition D1.

FIG. 11C is a cross-sectional view describing print states of the first layer and the second layer under the drying condition D2.

FIG. 11D is a cross-sectional view describing print states of the first layer and the second layer under the drying condition D3.

FIG. 11E is a cross-sectional view describing print states of the first layer and the second layer under the drying condition D1.

FIG. 11F is a cross-sectional view describing print states of the first layer and the second layer under the drying condition D2.

FIG. 11G is a cross-sectional view describing print states of the first layer and the second layer under the drying condition D3.

FIG. 12 is a table showing print conditions of print modes of the first embodiment and a comparative example.

FIG. 13 is a table showing print conditions of print modes of the second embodiment and the comparative example.

FIG. 14 is a table showing print conditions of print modes of a third embodiment and the comparative example.

FIG. 15 is a table showing print conditions of print modes of a fifth embodiment and the comparative example.

FIG. 16 is a table showing print conditions of print modes of a sixth embodiment and the comparative example.

FIG. 17 is a table showing a print condition of a print mode of a seventh embodiment.

FIG. 18A is a view for describing a relationship between a drying condition in an SW3 configuration and an immersion phenomenon and show through.

FIG. 18B is a cross-sectional view describing print states of the first layer and the second layer under the drying condition D1.

FIG. 18C is a cross-sectional view describing print states of the first layer and the second layer under the drying condition D2.

FIG. 18D is a cross-sectional view describing print states of the first layer and the second layer under the drying condition D3.

FIG. 18E is a cross-sectional view describing print states of the first layer and the second layer under the drying condition D1.

FIG. 18F is a cross-sectional view describing print states of the first layer and the second layer under the drying condition D2.

FIG. 18G is a cross-sectional view describing print states of the first layer and the second layer under the drying condition D3.

FIG. 19 is a table showing print conditions of print modes of an eighth embodiment and the comparative example.

FIG. 20 is a table showing print conditions of print modes of the fourth embodiment and the comparative example.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### Inkjet Print Apparatus

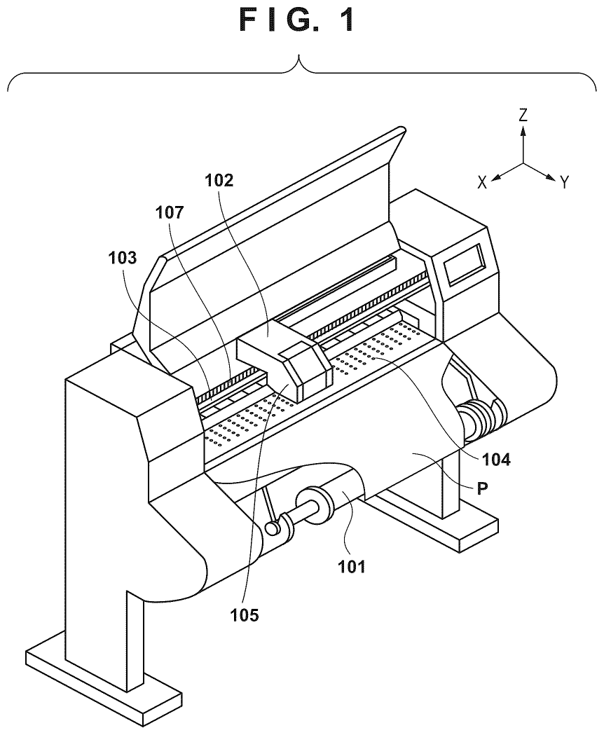

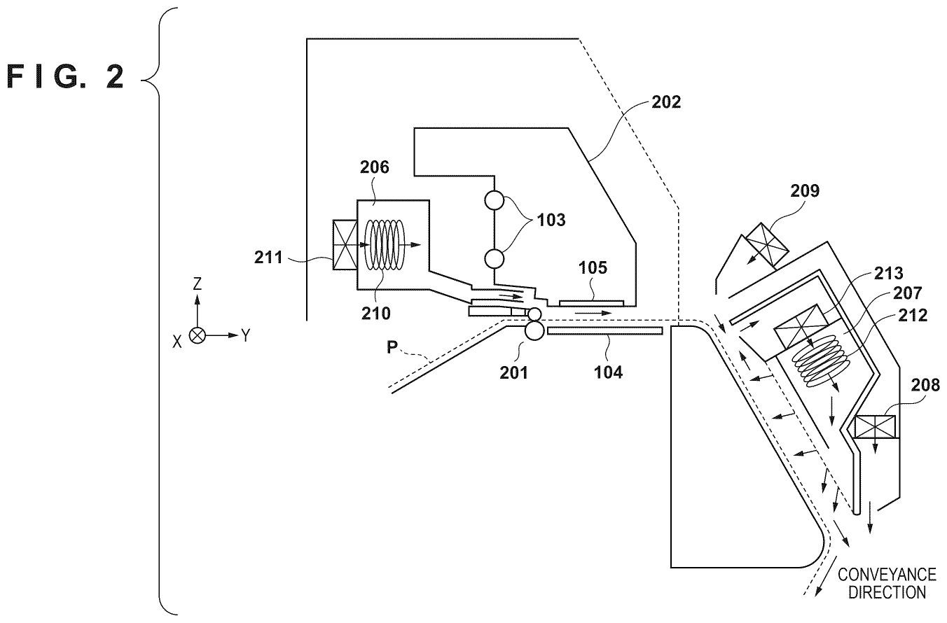

FIG. 1 is a perspective view of the external appearance of the inkjet print apparatus of the present embodiment. FIG. 2 is a side view illustrating the internal configuration of the inkjet print apparatus of the present embodiment. The inkjet print apparatus of the embodiment is what is called a serial scanning type, and prints an image by scanning a print head in an X direction (main scanning direction) that is a direction intersecting (here, orthogonal to) a Y direction (sub-scanning direction) that is a conveyance direction of a print medium P.

For example, the inkjet print apparatus of the present embodiment prints an image on a print medium that can transmit light. More specifically, the inkjet print apparatus discharges ink onto one surface of a transparent print medium to print an image in which at least a first layer and a second layer are layered in this order. The first layer may be an image printed with color ink. After printing and drying the first layer, the inkjet print apparatus prints the second layer on the first layer. The second layer is an image printed with white ink or the like, and functions as a concealment layer that suppresses transparency of the image of the first layer. Furthermore, the inkjet print apparatus may discharge color ink onto the second layer to print a third layer. The third layer may be an image.

An outline of a configuration of an inkjet print apparatus (hereinafter, also referred to as a print apparatus) and an operation at the time of print will be described with reference to FIGS. 1 and 2. At the time of image print, the print medium P held by a spool 101 is conveyed in the Y direction by the spool 101 via a gear by a conveyance unit driven by an LF motor 409 described later. A carriage unit 102 scans on the print medium P along a guide shaft 103 extending in the X direction at a predetermined conveyance position by a CR motor 410 described later. Specifically, the carriage unit 102 performs a reciprocal scan (reciprocal movement) between a forward path in the +X direction and a backward path in the −X direction. Then, in a process of this scan, a print head 105 mounted on the carriage unit 102 discharges ink from a nozzle while performing a reciprocal scan in synchronization with the timing based on a position signal obtained by an encoder 107 in the main scanning direction, to print an image on the print medium P.

Similarly to the print head 105, the print apparatus processes a detection signal corresponding to the position of the carriage unit 102 in synchronization with the timing based on the position signal obtained by the encoder 107 in the process of a reciprocal scan. Note that in the present embodiment, a carriage belt is used for transmission of a driving force from the CR motor 410 to the carriage unit 102. The driving method of the carriage unit 102 may be a method including, in place of the carriage belt, a lead screw extending in the X direction rotationally driven by, for example, a carriage motor, and an engagement portion provided in the carriage unit 102 and engaging with a groove of the lead screw. Furthermore, the driving method of the carriage unit 102 may be another system.

The print medium P is conveyed while being nipped between a paper feed roller and a pinch roller of a conveyance unit 201, and is guided to a print position (scan region of the print head 105) on a platen 104. In a normal idle state, capping is performed on a face surface of the print head 105. Therefore, the cap is opened prior to print, and the print head 105 and the carriage unit 102 are brought into a scannable state. Thereafter, when data for one scan is accumulated in a buffer, the print apparatus causes the carriage unit 102 to scan by the carriage motor and prints an image.

### Drying and Fixation During Image Print

The conveyance unit 201 includes a paper feed roller and a pinch roller, and conveys the print medium P. The print medium P is conveyed while being held by the spool 101, and after an image is printed by the print head 105, the print medium P is wound by the spool 101 and become a roll-shaped take-up medium. The print head 105 prints an image by discharging ink onto the print medium P while being scanned in the X direction by the carriage unit 202. At this time, the conveyance unit 201 intermittently conveys the print medium P in the +Y direction, thereby forming an image in a plane of the print medium P. The platen 104 faces the scan regions of the print head 105 and the carriage unit 202, and sucks the rear surface of the print medium P in order to prevent floating of the print medium P.

Next, the configuration for drying and fixing ink will be described.

A platen air blowing unit 206 includes a heater 210 and a fan 211. The platen air blowing unit 206 blows, by the fan 211, air heated by the heater 210 to the surface of the print medium P on the platen 104. The temperature and the speed of the air blown to the surface of the print medium P by the platen air blowing unit 206 may be controlled within a range of a predetermined upper limit and a predetermined lower limit. By this, the platen air blowing unit 206 promotes evaporation of moisture contained in the ink discharged onto the surface of the print medium P on the platen 104, and promotes drying of the ink. The platen air blowing unit 206 dries the ink simultaneously with printing of the image by the print head 105.

A fixing unit 207 includes a heater 212 and a fan 213. The fixing unit 207 dries and fixes the ink applied to the print medium P. The fixing unit 207 has a hollow box shape. The bottom surface of the fixing unit 207 faces the conveyance surface of the print medium P. The fixing unit 207 blows air heated by the heater 212 from the bottom surface toward the print medium P as hot air by the fan 213, thereby raising the temperature of the ink and the print medium P to evaporate water and a solvent contained in the ink and form an emulsion into a film.

A downflow unit 208 blows, toward the floor direction, hot air exhausted from the fixing unit 207. An air curtain unit 209 is provided between the platen 104 and the fixing unit 207. The air curtain unit 209 prevents ink mist flowed by the platen air blowing unit 206 from entering inside the fixing unit 207.

Here, the present print apparatus can perform what is called multipass printing in which an image is printed in a unit region (1/n band) on the print medium P by a plurality of times (n times) of print scans of the print head 105. Details of this multipass printing and the nozzle configuration for performing the multipass printing will be described later.

### Print Head

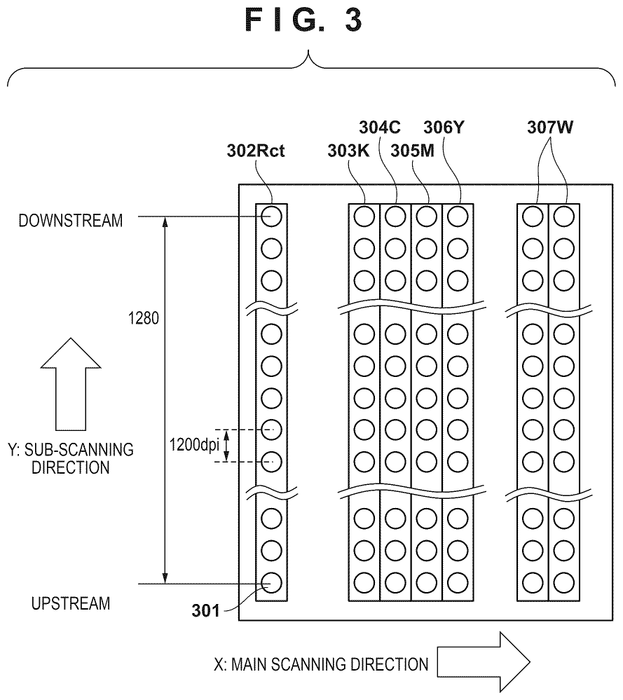

FIG. 3 is a schematic view of the configuration of the print head of the present embodiment observed from a nozzle surface. The arrangement of the nozzles of the print head and the like will be described with reference to FIG. 3.

The print head 105 includes a plurality of nozzle rows. One nozzle row has 1280 nozzles 301 arrayed in the Y direction at a density of 1200 per inch. The print head 105 includes a nozzle row 303K in which nozzles for discharging ink containing a black color material are arrayed, a nozzle row 304C in which nozzles for discharging ink containing a cyan color material are arrayed, a nozzle row 305M in which nozzles for discharging ink containing a magenta color material are arrayed, a nozzle row 306Y in which nozzles for discharging ink containing a yellow color material are arrayed, a nozzle row 307W in which nozzles for discharging a concealment ink (white ink) are arrayed, and a nozzle row 302Rct in which nozzles for discharging a reaction liquid are arrayed.

The print apparatus of the present embodiment discharges a reaction liquid that reacts with a solid content such as a color material and resin particles contained in the ink to promote aggregation of the solid content. In particular, when an image is printed on a low-permeability print medium and a non-permeable print medium described later, the reaction liquid and the ink come into contact with each other on the print medium, whereby the reaction liquid promotes thickening due to aggregation of the color material. As a result, a good image with suppressed beading can be printed. The reaction liquid preferably reacts not only with the color ink but also with the solid content contained in the concealment ink and raises the viscosity. In the present embodiment, the image of the color ink and the concealment ink is printed using an identical reaction liquid, but a plurality of reaction liquids respectively corresponding to the color ink and the concealment ink may be used. In this case, the print head 105 has nozzle rows that discharge the respective reaction liquids of the color ink and the concealment ink.

These nozzle rows are each connected to an ink tank not illustrated that stores corresponding ink. The ink tank supplies ink to each nozzle row. Note that the print head 105 and the ink tank used in the present embodiment may be integrally configured or may be configured to be separable from each other.

In the print head 105, an energy generating element (hereinafter, also called a print element) that generates discharge energy for discharging ink from a nozzle is arranged. As this energy generating element, the present embodiment includes an electrothermal transducer that locally heats ink to cause film boiling and discharges ink by the pressure. However, the present embodiment is not limited to this, and ink may be discharged using a piezoelectric element.

### Control System

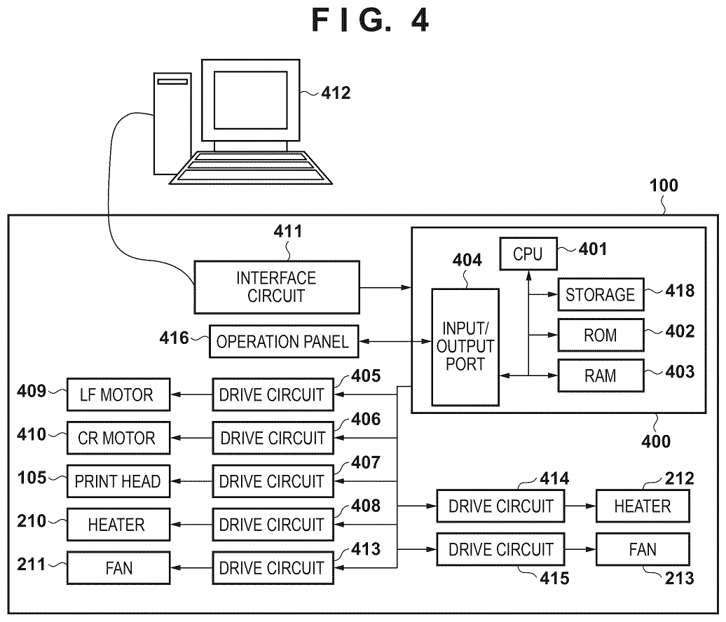

FIG. 4 is a block diagram illustrating the control system of the inkjet print apparatus 100 of the present embodiment. The control system of the print apparatus 100 will be described with reference to FIG. 4. The print apparatus 100 of the present embodiment includes a main control unit 400, the LF motor 409, the CR motor 410, a drive circuit 405, a drive circuit 406, a drive circuit 407, a drive circuit 408, a drive circuit 413, a drive circuit 414, a drive circuit 415, the print head 105, the heater 210, the fan 211, the heater 212, the fan 213, an interface circuit 411, and an operation panel 416.

The main control unit 400 is an example of a control apparatus and may be a computer. The main control unit 400 includes a CPU 401, a ROM 402, a RAM 403, an input/output port 404, and a storage 418. The CPU 401, the ROM 402, the RAM 403, the input/output port 404, and the storage 418 are connected to one another so as to be able to transmit/receive data to/from one another.

The CPU 401 is an abbreviation for central processing unit, and is an arithmetic apparatus. The CPU 401 controls the entire print apparatus 100. The CPU 401 executes, for example, processing operations such as calculation, selection, determination, and control, and print operations. The main control unit 400 may include other processors such as a micro processing unit (MPU), a graphics processing unit (GPU), a neural processing unit (NPU), and a quantum processing unit (QPU) in place of the CPU 401 or in addition to the CPU 401. Some or all of the functions of the main control unit 400 are realized by one or a plurality of processors including the CPU 401 reading a program stored in the storage 418, developing the program in the RAM 403, and executing the program. Some or all of the functions of the main control unit 400 may be realized by one or a plurality of circuits such as an application specific integrated circuit (ASIC) and a programmable logic device (PLD) including a field programmable gate array (FPGA).

The CPU 401 controls printing of the first layer and the second layer based on the setting of the print mode including a first print mode and a second print mode in which the concealment rates of the second layer are different from each other. The CPU 401 controls drying of the first layer based on the drying condition in accordance with the concealment rate of the print mode.

The ROM 402 is an abbreviation for read only memory, and is a nonvolatile storage apparatus. The ROM 402 stores a control program and the like to be executed by the CPU 401.

The RAM 403 is an abbreviation for random access memory, and is a memory that can read and write data at high speed. The RAM 403 is used as a buffer or the like for print data. The RAM 403 functions as a work area when the CPU 401 executes a program.

The storage 418 may be a nonvolatile, large-capacity storage apparatus such as a hard disk drive (HDD) and a solid state drive (SSD). The storage 418 stores, for example, a computer program to be executed by the CPU 401, data such as a mask pattern necessary for execution of the program, data of a type of a print medium in which an image is printed, print data including a drying condition and a print condition for printing an image, and data such as image data that is a processing target of the program.

The input/output port 404 is a port for inputting/outputting data to/from another device. The input/output port 404 is connected to the drive circuits 405, 406, 407, 408, 413, 414, and 415 of the LF motor 409 also called a conveyance motor, the CR motor 410 also called a carriage motor, the print head 105, the heater 210, the fan 211, the heater 212, and the fan 213. The input/output port 404 is connected to the operation panel 416 that can be operated by a user. The operation panel 416 is, for example, a touch panel that can display an image. The operation panel 416 may be an input device such as a keyboard and a mouse. The input/output port 404 passes the user's input received from the operation panel 416 to the CPU 401.

The interface circuit 411 is an interface for transmitting/receiving data to/from an external apparatus. The interface circuit 411 connects the main control unit 400 and a PC 412, which is a host computer, so as to be able to transmit/receive data. PC is an abbreviation for personal computer.

The user inputs image data to the print apparatus 100 via the PC 412, and inputs various types of information to the print apparatus 100 via the PC 412 and the operation panel 416.

In the main control unit 400, the CPU 401 converts the image data input from the PC 412 into print data and stores the print data in the RAM 403. Specifically, the CPU 401 acquires image data represented by information (0 to 255) of 8-bit, 256-value information for each of RGBW. The CPU 401 converts the acquired image data into multi-valued data represented by K, C, M, Y, and W used for printing. The CPU 401 generates multi-valued data represented by 8-bit, 256-value information (0 to 255) that defines the tone of each ink of K, C, M, Y, and W in each pixel group including a plurality of pixels by color conversion processing.

Next, the CPU 401 executes quantization of multi-valued data represented by K, C, M, Y, and W, and generates quantization data (binary data) represented by 1-bit, 2-value information (0, 1) that defines discharge or non-discharge of each ink of K, C, M, Y, and W with respect to each pixel. As this quantization processing, the CPU 401 may use various known quantization methods such as an error diffusion method, a dither method, and an index method.

Thereafter, the CPU 401 performs distribution processing of distributing the quantization data to a plurality of times of scan with respect to a unit region of the print head 105. Through the distribution processing, the CPU 401 generates print data represented by 1-bit, 2-value information (0, 1) that determines discharge or non-discharge of each ink of K, C, M, Y, and W with respect to each pixel in each of a plurality of times of scan with respect to the unit region of the print medium P. This distribution processing corresponds to the plurality of times of scan. The CPU 401 executes discharge of ink using a mask pattern that determines permission or non-permission of discharge if ink for each pixel. Note that the generation of the print data is not limited to being executed by the main control unit 400, and may be executed by the PC 412, or part of the processing may be executed by the PC 412, which is a host computer, and the remaining processing may be executed by the main control unit 400.

### Multipass Layering Print Method

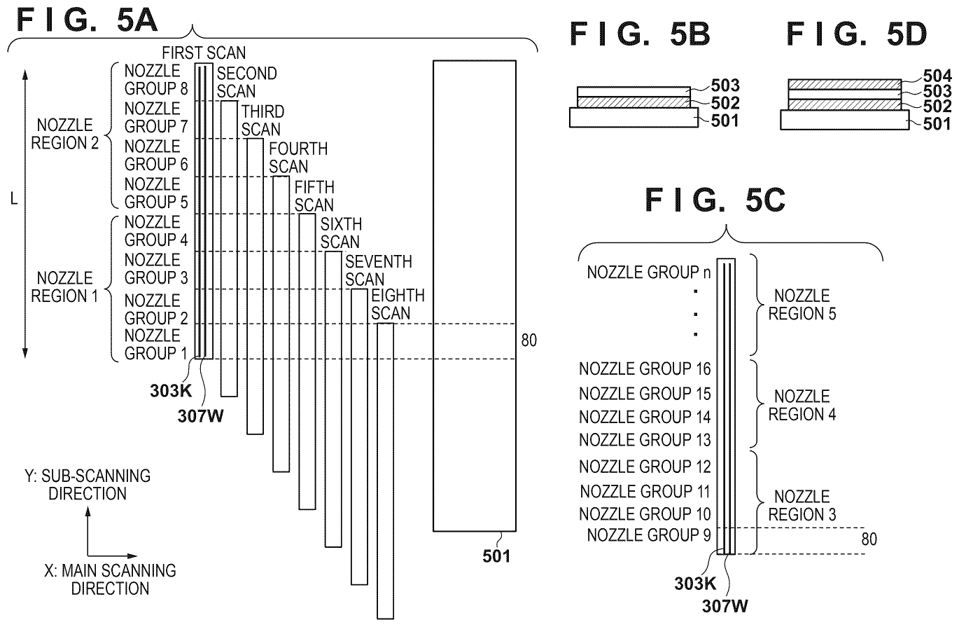

In the present embodiment, an image is printed by what is called multipass printing in which printing is performed by a plurality of times of scan with respect to a predetermined region on the print medium P using each ink of K, C, M, Y, and W. FIGS. 5A to 5D are views for describing multipass layering printing.

A multipass printing method in which different inks are layered and printed by varying the region of the nozzle row to be used by the color of the ink for multipass printing using the entire region of the nozzle row will be described below using W ink and K ink as examples.

FIG. 5A is a view describing the nozzle region 1 corresponding to nozzle groups 1 to 4 and the nozzle region 2 corresponding to nozzle groups 5 to 8 among all the nozzles of the nozzle rows 303K and 307W. FIG. 5B is a cross-sectional view describing a two-layer image. Of the nozzle row 303K and the nozzle row 307W, a region corresponding to the nozzle groups 1 to 4 is defined as the nozzle region 1, and a region corresponding to the nozzle groups 5 to 8 is defined as the nozzle region 2. The length of the entire region of the nozzle row is L.

Of the nozzle groups 1 to 8 illustrated in FIG. 5A, the K ink is discharged by the nozzle groups 1 to 4 corresponding to the nozzle region 1, and the W ink is discharged by the nozzle groups 5 to 8 corresponding to the nozzle region 2. Here, the print data of the K ink is distributed such that the printing of the image is completed in the first to fourth scans, and the print data of the W ink is distributed such that the printing of the image is completed in the fifth to eighth scans.

First, in the first scan, the print apparatus discharges the K ink from the nozzle group 1 in the nozzle row 303K of the print head 105 to a predetermined region 80 of a transparent print medium 501 in accordance with the print data of the K ink corresponding to the first scan. After this first scan ends, the print apparatus conveys the transparent print medium 501 by a distance L/8 corresponding to one nozzle group in the sub-scanning direction (Y direction). For the sake of simplicity, FIG. 5A illustrates that the print head is moved upstream in the sub-scanning direction between scans.

Thereafter, the print apparatus alternately performs discharge from the print head 105 and conveyance of the print medium, and performs the second to fourth scans. By this, the print apparatus discharges the K ink from the nozzle groups 2 to 4 in the nozzle row 303K with respect to the predetermined region 80 having the width corresponding to the distance L/8 corresponding to one nozzle group, and completes the image of the K ink at the printing of the fourth scan. Subsequently, the print apparatus discharges the W ink from the nozzle group 5 in a nozzle row 506W to the predetermined region 80 having the width corresponding to the distance L/8 corresponding to one nozzle group in accordance with the print data of the W ink corresponding to the fifth scan. Thereafter, the print apparatus alternately performs conveyance of the transparent print medium 501 and discharge of the W ink from the print head 105, and discharges the W ink from the nozzle groups 5 to 8 in the nozzle row 506W in the fifth to eighth scans with respect to the predetermined region 80. In this manner, the print apparatus completes the multipass printing with respect to the predetermined region 80 having the width corresponding to the distance L/8 corresponding to one nozzle group.

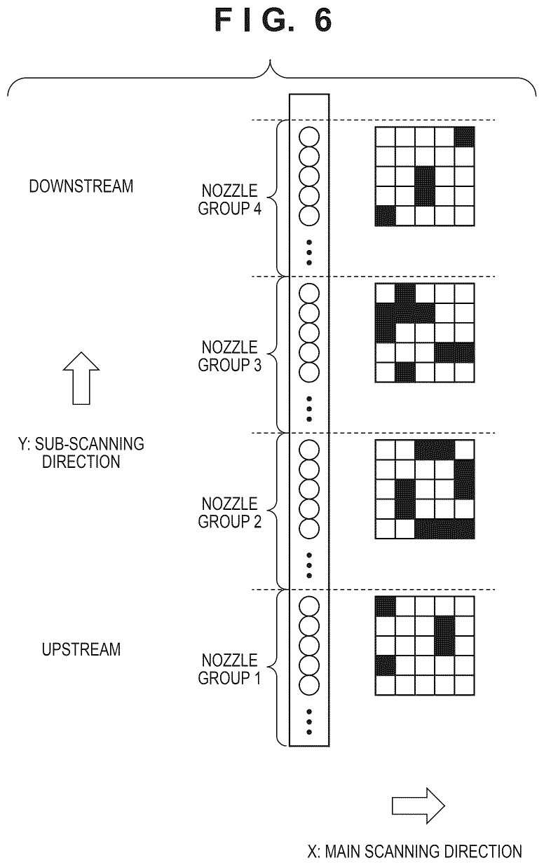

FIG. 6 is a view illustrating a mask pattern. In the mask pattern illustrated in FIG. 6, pixels filled in black indicate pixels (hereinafter, also referred to as print permitted pixels) that permit ink discharge when ink discharge is determined by quantization data. In FIG. 6, pixels indicated in white indicate pixels (hereinafter, also referred to as non-print permitted pixels) that do not permit ink discharge even when ink discharge is determined by quantization data. FIG. 6 illustrates a mask pattern having a size of 5 pixels×5 pixels. By repeatedly applying the mask pattern of FIG. 6 in the X direction and the Y direction, the distribution processing is performed for all the quantization data corresponding to each unit region.

The number of pixels that permit discharge that exist in each of the four mask patterns illustrated in FIG. 6 is 5 pixels×5 pixels=25 pixels. That is, the print permission rate is 100% when four pixels that permit discharge the mask pattern of 5 pixels×5 pixels are added. By performing logical product (AND) processing of a part of the binary data (size of 5 pixels×5 pixels) of each ink and a mask pattern corresponding to each print scan (each pass), the CPU 401 can generate print data for applying ink in each print scan. In the mask pattern corresponding to each scan, four print permitted pixels are arranged in the mask pattern corresponding to the first scan (nozzle group 1). Therefore, the print permission rate of the mask pattern corresponding to the first scan is about 16% (=4/25 x 100). Hereinafter, the print permission rates of the mask patterns corresponding to the second scan (nozzle group 2) to the fourth scan (nozzle group 8) are 32%, 36%, and 16%, respectively. Therefore, use of this mask pattern enables the print apparatus to distribute the ink so as to be discharged over the entire nozzle row of the print head 105. Note that the pattern illustrated in FIG. 6 is a view in which a part of the mask pattern is extracted for simplicity, and there is a part slightly different from the print permission rate.

By dividing the nozzle row groups for use of the K ink and the W ink as illustrated in FIG. 5A, the print apparatus prints the image of the K ink in the first four scans of the eight scans for the predetermined region 80, and prints the image of the W ink in the last four scans. That is, the print apparatus prints the image of the W ink overlaid on the image printed with the K ink in the predetermined region 80. By this, as illustrated in FIG. 5B, the print apparatus can print an image in which a first layer 502 and a second layer 503 are layered on the transparent print medium 501. Such a layered configuration is referred to as overflood. Hereinafter, overflood is omitted and referred to as an OF configuration.

FIG. 5C is a view describing three nozzle regions formed by dividing all the nozzles of the nozzle rows 303K and 307W into three. FIG. 5D is a cross-sectional view describing a three-layer image.

Furthermore, in a case where three layers of images are layered and printed in n times of print scans, the print apparatus divides the nozzle row into nozzle groups from a nozzle group 9 to a nozzle group n as illustrated in FIG. 5C, and divides the nozzle group into three of the nozzle region 1, the nozzle region 2, and a nozzle region 3. The print apparatus discharges the K ink in the nozzle region 1, discharges the W ink in the nozzle region 2, and discharges the K ink in the nozzle region 3. In this case, the width of the predetermined region 80 to be printed in one scan is L/n in which the length L of the entire nozzle row is divided by n. Therefore, the feed amount 1 in the sub-scanning direction of the transparent print medium 501 in one scan is the distance L/n. In this manner, by dividing the nozzle groups that discharge the K ink and the W ink, the print apparatus can overlay an image printed with white ink on an image printed with the K ink and further overlay an image printed with the K ink on the transparent print medium 501. By this, as illustrated in FIG. 5D, the print apparatus prints an image in which the first layer 502, the second layer 503, and a third layer 504 are layered on the transparent print medium 501. Such a layered configuration is referred to as a sandwich three-layer configuration. Hereinafter, the sandwich three-layer configuration is omitted and referred to as an SW3 configuration.

### Data Generation and Print Mode Selection

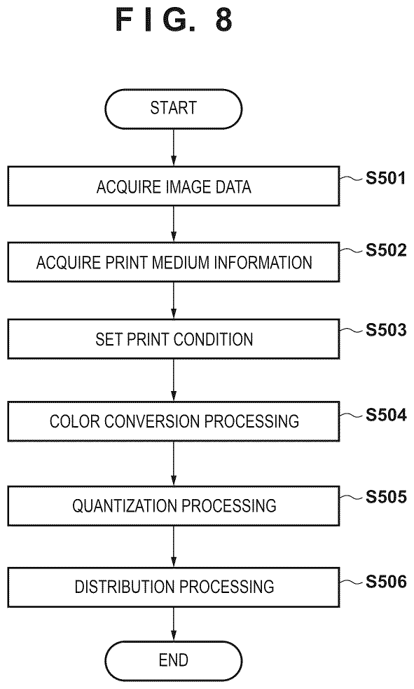

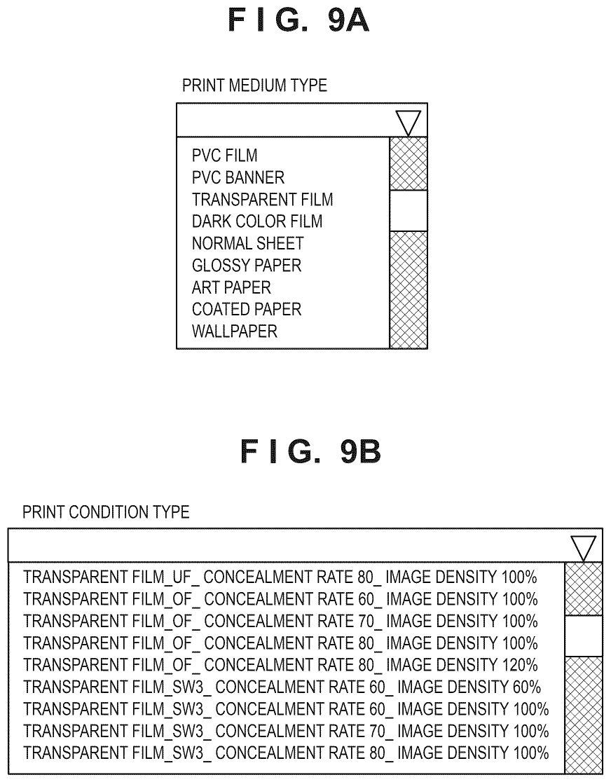

FIG. 8 is a flowchart of print data generation processing executed by the CPU 401 in accordance with a control program in the present embodiment. FIGS. 9A and 9B are views illustrating examples of a user interface (UI) for selecting the print condition of the print mode. The print data generation processing is processing of generating print data used for print an image. The print data generation processing is also part of image processing.

First, in step S501, the CPU 401 of the print apparatus 100 acquires image data in an RGBW format input from the PC 412, which is a host computer.

In step S502, the CPU 401 acquires information (hereinafter, also called print medium information) regarding the type of the print medium used for print. The print medium information is an example of a print condition. In the present embodiment, the user selects and inputs the type of the print medium used for print with the PC 412 or the operation panel 416. By this, the CPU 401 acquires the print medium information corresponding to the user's input.

For example, the user selects a print medium on which an image is printed from a plurality of print media via the UI as in FIG. 9A displayed on a monitor of the PC 412. The CPU 401 of the print apparatus 100 acquires the print medium information selected by the user via the PC 412 and the interface circuit 411.

Note that although a form in which the user inputs the print medium information via the UI has been described here, the input method is not limited to this. For example, the print apparatus may include a sensor for determining the type of the print medium, and the CPU 401 may automatically acquire the print medium information in accordance with the determination result of the sensor. Other than the type of the print medium registered in advance, the user may newly register a type of a print medium.

Next, in step S503, one print condition is set from among a plurality of print conditions in accordance with the print medium information acquired in step S502.

For example, the user may select one print condition for performing print from among the plurality of print conditions via the UI as in FIG. 9B displayed on the monitor of the PC 412, the operation panel 416, or the like.

Any of the ROM 402 and the storage 418 of the print apparatus stores a plurality of pieces of print medium information in advance, and stores print data including a drying condition and a print condition to be used for each print medium.

Next, in step S504, the CPU 401 performs color conversion processing of converting image data of the value (RGBW value) indicated by an RGB signal into multi-valued data corresponding to each ink (C, M, Y, K, RCT and W) used for printing. The CPU 401 generates multi-valued data represented by 8-bit, 256-value information that defines the tone of each ink in each pixel group including a plurality of pixels by the color conversion processing.

Thereafter, in step S505, the CPU 401 performs quantization processing of quantizing the multi-valued data. The CPU 401 generates quantization data represented by 1-bit, 2-value information that defines discharge or non-discharge of each ink with respect to each pixel by the quantization processing. Note that as a method of this quantization, a method such as dither processing and error diffusion processing can be applied.

Then, in step S506, the CPU 401 performs distribution processing of distributing the quantization data of each ink to a plurality of times of scan of the print head in multipass printing. The CPU 401 generates print data represented by 1-bit, 2-value information that defines discharge or non-discharge of each ink with respect to each pixel in each of the plurality of times of scan with respect to the unit region on the print medium by the distribution processing. The print apparatus of the present embodiment prints an image on the print medium by discharging the ink from the print head in accordance with the print data generated as described above.

Note that a form in which the CPU 401 in the print apparatus 100 executes the entire processing of S501 to S506 has been described here, but other forms can be performed. For example, a form in which the PC 412 executes the entire processing of S501 to S506 may be adopted. For example, a form in which the PC 412 executes up to the color conversion processing (S504), and the print apparatus 100 executes the quantization processing (S505) and subsequent processing may be adopted.

### Material Outline

### Ink

The ink used in the present embodiment may be a liquid material that can be discharged from the nozzle. The ink of the present embodiment contains a liquid solvent that volatilizes and solid content that forms a print layer by each printed image. Examples of the solvent include an organic solvent and water. The ink may contain water-soluble resin particles for bringing the print medium and the color material into close contact with each other and improving the abrasion resistance (fixability) of the print layer.

As the ink (K, C, M, and Y) for an image layer, any of a pigment and a dye can be used as the color material. As the concealment ink (W) for a concealment layer, for example, silicon dioxide, mica, aluminum oxide, boehmite, titanium oxide, barium titanate, zirconium oxide, zinc oxide, barium sulfate, niobium oxide, which are white color materials, can be used in addition to the material used for the image ink. Among them, titanium oxide may be used as the concealment ink (W) from the viewpoint of a high refractive index and the cost. As the concealment ink (W), a metallic material containing a metal pigment may be used for the purpose of imparting special gloss.

In the ink to be used in the present embodiment, a material containing a water-soluble organic solvent may be used as an organic solvent. The boiling point of the water-soluble organic solvent may be 150° C. or more and 300° C. or less for the reason of wettability and moisture retention of a head face surface. The organic solvent may be a ketone-based compound such as acetone or cyclohexanone, a propylene glycol derivative such as tetraethylene glycol dimethyl ether, a heterocyclic compound having a lactam structure represented by N-methyl-pyrrolidone and 2-pyrrolidone, or the like, from the viewpoint of the function of a film formation aid with respect to the resin particles and the swelling solubility on a printed medium on which a resin layer is formed. The content of the water-soluble organic solvent may be 3 wt % or more and 30 wt % or less from the viewpoint of discharge performance. Examples of the water-soluble organic solvent may include, for example, alkyl alcohols having 1 to 4 carbon atoms such as methyl alcohol, ethyl alcohol, n-propyl alcohol, isopropyl alcohol, n-butyl alcohol, sec-butyl alcohol, and tert-butyl alcohol, amides such as dimethylformamide and dimethylacetamide, ketones or ketoalcohols such as acetone and diacetone alcohol, ethers such as tetrahydrofuran and dioxane, polyalkylene glycols such as polyethylene glycol and polypropylene glycol, alkylene glycols in which an alkylene group contains 2 to 6 carbon atoms such as ethylene glycol, propylene glycol, butylene glycol, triethylene glycol, 1,2,6-hexanetriol, thiodiglycol, hexylene glycol, and diethylene glycol, lower alkyl ether acetates such as polyethylene glycol monomethyl ether acetate, lower alkyl ethers of polyhydric alcohols such as glycerin, ethylene glycol monomethyl (or ethyl) ether, diethylene glycol methyl (or ethyl) ether, and triethylene glycol monomethyl (or ethyl) ether, polyhydric alcohols such as trimethylolpropane and trimethylolethane, N-methyl-2-pyrrolidone, 2-pyrrolidone, and 1,3-dimethyl-2-imidazolidinone. The water-soluble organic solvent as described above may be used alone or as a mixture. As the water, deionized water may be used. In the ink to be used in the present embodiment, a surfactant, an antifoaming agent, a preservative, an antifungal agent, and the like can be appropriately added in addition to the above components in order to have a desired physical property value as necessary.

### Reaction Liquid

In the present embodiment, a reaction liquid may be used for the purpose of image formation. The reaction liquid used in the present embodiment contains a reactive component that reacts with the color material and the resin particles contained in the ink and aggregates or gels the color material and the resin particles. Specifically, when mixed on a print medium or the like with a first ink for a base layer or a second ink for an image layer having a color material or resin particles stably dispersed or dissolved in an aqueous medium by the action of an ionic group, this reactive component can destroy the dispersion stability of the first ink for the base layer or the second ink for the image layer. In the present embodiment, an anionic color material is used, and therefore the reactants can be roughly classified into an acid-based reactant, a polyvalent metal-based reactant, and a cationic polymer-based reactant. The acid-based reactant can be roughly classified into an inorganic acid and an organic acid. In the present embodiment, the organic acid will be described, but the acid-based reactant is not limited to the organic acid. Examples of the water-soluble organic acid include oxalic acid, polyacrylic acid, formic acid, acetic acid, propionic acid, glycolic acid, malonic acid, malic acid, maleic acid, ascorbic acid, levulinic acid, succinic acid, glutaric acid, glutamic acid, fumaric acid, citric acid, tartaric acid, lactic acid, pyrrolidone carboxylic acid, pyrone carboxylic acid, pyrrole carboxylic acid, furancarboxylic acid, pyridine carboxylic acid, coumaric acid, thiophene carboxylic acid, nicotinic acid, oxysuccinic acid, and dioxysuccinic acid. The content of the organic acid may be 3.0 mass % or more and 90.0 mass % or less, and further may be 5.0 mass % or more and 70.0 mass % or less, based on the total mass of the composition contained in the reaction liquid. The polyvalent metal-based reactant may be as follows. For example, the polyvalent metal-based reactant may be divalent metal ions such as Ca2+, Cu2+, Ni2+, Mg2+, Zn2+, Sr2+, and Ba2+. Furthermore, the polyvalent metal-based reactant may be, but is not limited to, trivalent metal ions such as A13+, Fe3+, Cr3+, and Y3+. In order to contain these polyvalent metal ions into the reaction liquid, salt of a polyvalent metal may be used. The salt of the polyvalent metal is metal salt composed of polyvalent metal ions as mentioned above and anions that bind to these ions, but is required to be soluble in water. The anions for forming the salt of the polyvalent metal may be, but is not limited to, for example, Cl−, NO3−, I−, Br−, ClO3−, SO42−, CO32−, CH3COO−, HCOO−, and the like. In the present embodiment, the polyvalent metal ions may be Ca2+, Mg2+, Sr2+, Al3+, Y3+, and the like from the viewpoint of reactivity, colorability, ease of handling, and the like. In particular, Ca2+ is high in ease of handling. The polyvalent metal ion and the anion for forming salt may be methanesulfonic acid from the viewpoint of safety and the like. The cationic polymer-based reactant may be soluble in water. The cationic polymer may be polyallylamine hydrochloride, polyamine sulfonate, polyvinylamine hydrochloride, chitosan acetate, or the like. The cationic polymer-based reactant may be a copolymer of vinylpyrrolidone whose nonionic polymeric substance has been partially cationized and aminoalkyl alkylate quaternary salt, a copolymer of acrylamide and aminomethylacrylamide quaternary salt, or the like. The reaction liquid containing a cationic polymer as a reactive component may be colorless, but does not necessarily need to show absorption in the visible range. That is, the reaction liquid may show absorption in the visible range, or may have a light color that shows absorption in the visible range as long as it does not substantially affect the image when the image is printed. Note that the reaction liquid is not necessarily used in all printing, and is applied by an amount necessary for image printing in view of the ink application amount.

### Print Medium

As the print medium used in the present embodiment, a liquid non-absorptive and low-absorptive print medium may be applied. Examples of the liquid non-absorptive print medium include those not produced as a print medium for aqueous inkjet ink, such as glass, plastic, films, and Yupo. Examples of the print medium can include those not subjected to surface treatment for inkjet printing (i.e., an ink absorption layer is not formed), such as a plastic film and a base material such as paper coated with plastic. Examples of the plastic include polyvinyl chloride, polyethylene terephthalate, polycarbonate, polystyrene, polyurethane, polyethylene, and polypropylene. Examples of the low-permeability print medium specifically include print media such as recording paper used for offset printing or the like such as art paper and coated paper.

### Characteristic Configuration 1

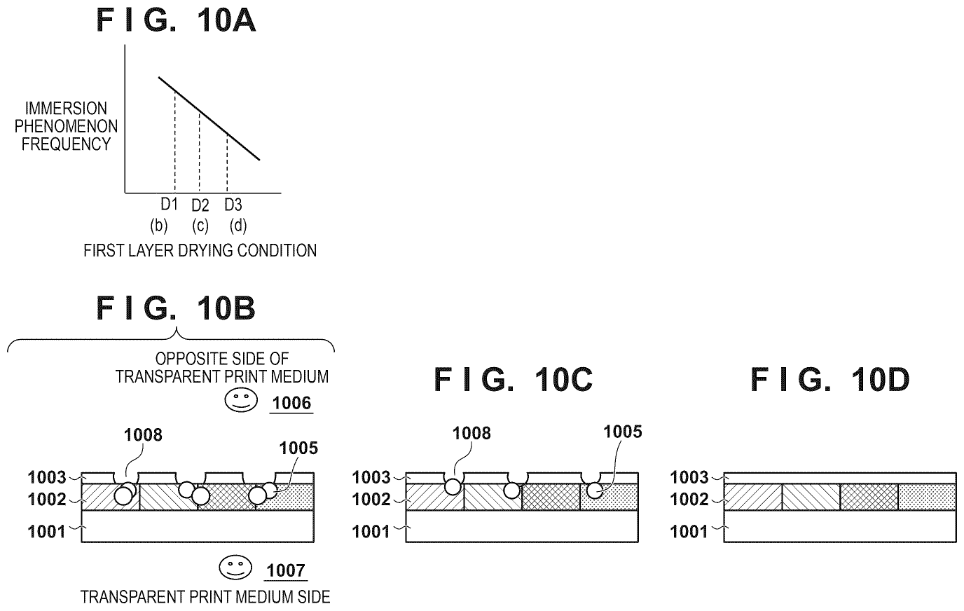

The OF configuration will be described. FIGS. 10A to 10D are views describing immersion and show through. The immersion phenomenon will be described with reference to FIGS. 10A to 10D. FIG. 10A is a view for describing a relationship between the drying condition of the first layer 1002 and the immersion amount of the second layer 1003.

The vertical axis indicates the frequency of the immersion phenomenon in which the concealment ink of the second layer 1003 sinks into the first layer 1002. Moving to the upper side on the vertical axis indicates a higher frequency of the immersion phenomenon. The horizontal axis indicates the drying condition at the time of printing of the first layer 1002. Moving to the right indicates a stronger drying condition. On the horizontal axis, (b), (c), and (d) represent FIGS. 10B, 10C, and 10D, respectively. The drying conditions D1, D2, and D3 indicate the drying conditions at the time of printing of the first layer 1002. FIGS. 10B, 10C, and 10D are cross-sectional views of respective layers for describing print states of the first layer 1002 and the second layer 1003 when the first layer 1002 is printed on a transparent print medium 1001 under the drying conditions D1, D2, and D3, respectively.

When the drying condition of the first layer 1002 is weak as illustrated in the drying condition D1 of FIG. 10A, an immersion phenomenon 1008 in which a concealment ink 1005 of the second layer 1003 is immersed in the first layer 1002 tends to occur frequently as illustrated in FIG. 10B. The phenomenon in which the concealment ink 1005 of the second layer 1003 is immersed in the first layer 1002 correlates with the drying condition of the first layer 1002. The stronger the drying condition of the first layer 1002 becomes, the less likely the immersion phenomenon 1008 is to occur as illustrated in FIGS. 10B, 10C, and 10D. This correlation between the immersion phenomenon 1008 and the drying condition varies depending on the difference in aggregation strength and evaporation rate between the ink and the reaction liquid. Specifically, the correlation between the immersion phenomenon 1008 and the drying condition changes as the ink composition, the reaction liquid composition, and the drying ability of the platen air blowing unit 206 change. However, in common in any case, there is a tendency that the immersion amount increases when the drying condition of the first layer 1002 is weak, and the immersion amount decreases when the drying condition of the first layer 1002 is strong.

Next, an adverse effect caused by immersion will be described. Examples of the adverse effect caused by immersion include a show through phenomenon. As illustrated by the immersion phenomenon 1008 in FIG. 10B and the immersion phenomenon 1008 in FIG. 10C, the second layer 1003 becomes thin at locations where the concealment ink of the second layer 1003 is immersed, and the second layer 1003 becomes discontinuous in some locations. By this, when the observer observes the image from an opposite side 1006 of the transparent print medium 1001, the first layer 1002 is not sufficiently concealed by the second layer 1003, and a phenomenon called show through in which the image of the first layer 1002 can be visually recognized occurs. Since a window sign is displayed on transparent glass, the window sign may be observed not only from a side 1007 of the transparent print medium 1001 but also from the opposite side 1006 of the transparent print medium 1001, and show through is a problem in terms of image quality.

In the known technique, the drying condition at the time of printing of the first layer 1002 is strengthened as in the drying condition D3, and immersion is suppressed as in FIG. 10D, thereby solving show through of the image. In the known technique, there is no problem in image quality, but the drying condition of the first layer 1002 is uniformly strengthened regardless of the concealment rate of the second layer 1003, thereby leading to a productivity decrease or a power consumption increase.

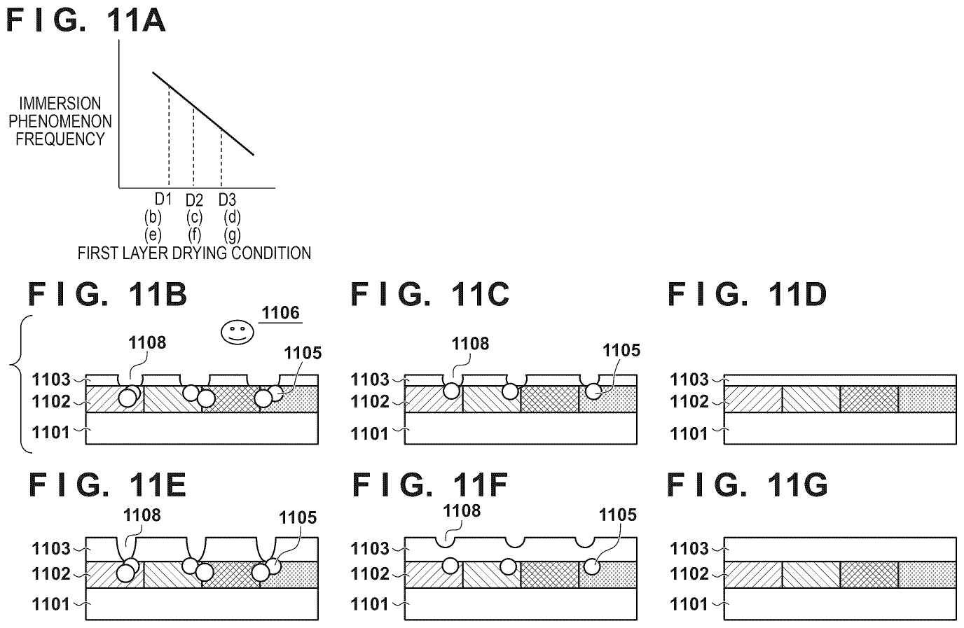

Therefore, the CPU 401 of the present embodiment dries the first layer by setting a drying condition in accordance with the concealment rate of the second layer. FIGS. 11A to 11G are views for describing the relationship between the drying conditions in the OF configuration and the immersion phenomenon and show through.

FIG. 11A is a conceptual diagram for describing a relationship between the drying condition of the first layer and the immersion amount of the second layer. The vertical axis indicates the frequency of an immersion phenomenon 1108 in which a concealment ink 1105 of a second layer 1103 is immersed in a first layer 1102 on a transparent print medium 1101. Moving to the upper side on the vertical axis indicates a higher frequency of the immersion phenomenon 1108. The horizontal axis indicates a drying condition at the time of image printing of the first layer 1102. Moving to the right on the horizontal axis indicates a stronger drying condition. The drying conditions D1, D2, and D3 indicate the drying conditions at the time of print of the first layer 1102.

FIGS. 11B to 11G are cross-sectional views for describing print states of the first layer 1102 and the second layer 1103. FIGS. 11B and 11E are views when printing is performed under the drying condition D1. FIGS. 11C and 11F are views when printing is performed under the drying condition D2. FIGS. 11D and 11G are views when printing is performed under the drying condition D3. Furthermore, FIGS. 11B, 11C, and 11D are views when the concealment rate of the second layer 1103 is low. FIGS. 11E, 11F, and 11G are views when the concealment rate of the second layer 1103 is high.

With reference to FIGS. 11B to 11G, the relationship between the drying condition and show through and the relationship between the concealment rate and show through will be described.

As illustrated in FIGS. 11B, 11C, and 11D, when the drying condition becomes strong, immersion tends to hardly occur, and show through in a case of being viewed from an opposite side 1106 of the transparent print medium 1101 hardly occurs. However, in a case where the concealment rate is low, even if the drying condition is strengthened to D2 to slightly reduce the immersion phenomenon 1108, the second layer 1103 is thin and the concealment rate is low, and therefore show through is likely to occur. Therefore, when the concealment rate is low, in order to suppress show through, it is necessary to dry the first layer 1102 by sufficiently strengthening the drying condition as indicated by D3.

On the other hand, when the second layer 1103 is thick and the concealment rate is high, show through is less likely to occur even under the drying condition D2, as illustrated in FIGS. 11E, 11F, and 11G. That is, even if the drying condition is not strengthened to D3, the influence of show through on the image quality is minor.

From this, since the influence of show through is minor when the concealment rate is high, the drying condition of the first layer 1102 can be weakened as compared with a case where the concealment rate is low. That is, in the print mode having a high concealment rate, it is possible to increase productivity or suppress power consumption by weakening the drying condition.

### Characteristic Configuration 2

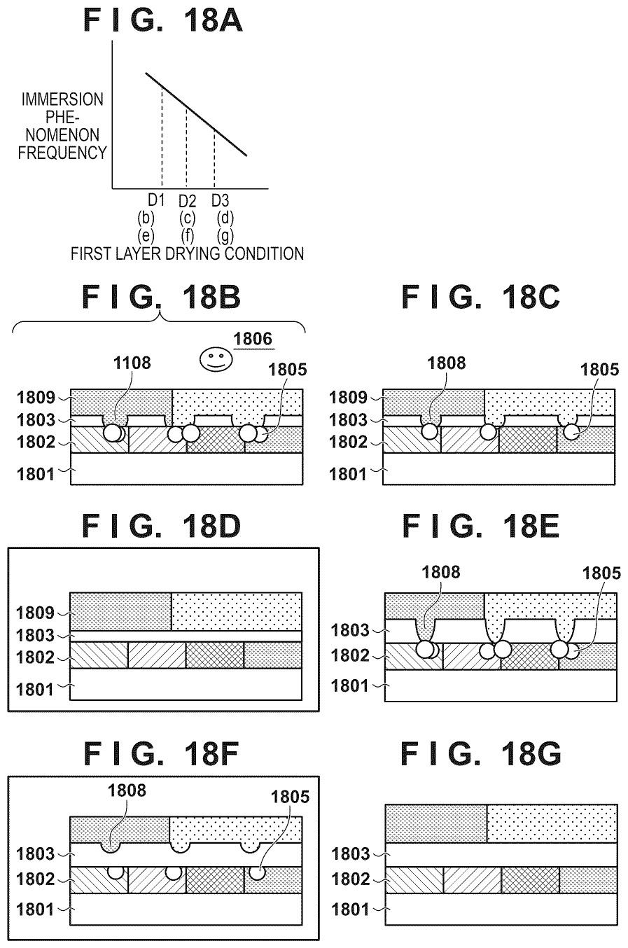

The SW3 configuration will be described. Also in the SW3 configuration, an immersion phenomenon and show through accompanying the immersion phenomenon occur similarly to the OF configuration. FIGS. 18A to 18G are views for describing the relationship between the drying conditions in the SW3 configuration and the immersion phenomenon and show through.

FIG. 18A is a conceptual diagram for describing a relationship between the drying condition of the first layer and the immersion amount of the second layer. The vertical axis indicates the frequency of an immersion phenomenon 1808 in which a concealment ink 1805 of a second layer 1803 is immersed in a first layer 1802 on a transparent print medium 1801. Moving to the upper side on the vertical axis indicates a higher frequency of the immersion phenomenon 1808. The horizontal axis indicates a drying condition at the time of image printing of the first layer 1802. Moving to the right on the horizontal axis indicates a stronger drying condition. The drying conditions D1, D2, and D3 indicate the drying conditions at the time of printing of the first layer 1802.

FIGS. 18B to 18G are cross-sectional views for describing print states of the first layer 1802 and the second layer 1803. FIGS. 18B and 18E are views when printing is performed under the drying condition D1. FIGS. 18C and 18F are views when printing is performed under the drying condition D2. FIGS. 18D and 18G are views when printing is performed under the drying condition D3. Furthermore, FIGS. 18B, 18C, and 18D are views when the concealment rate of the second layer 1803 is low. FIGS. 18E, 18F, and 18G are views when the concealment rate of the second layer 1803 is high.

In a case where the second layer 1803 is thin and the concealment rate is low, show through is likely to occur when an image of a third layer 1809 is viewed from an opposite side 1806 of the transparent print medium 1801 even if the drying condition is strengthened to D2 to slightly reduce the immersion phenomenon, as illustrated in FIGS. 18B, 18C, and 18D. Therefore, also in the SW3 configuration, when the concealment rate is low, it is necessary to sufficiently dry the first layer 1802 by strengthening the drying condition to D3.

On the other hand, in a case where the second layer 1803 is thick and the concealment rate is high, show through is less likely to occur if the drying condition is strengthened to D2 as illustrated in FIGS. 18E, 18F, and 18G. That is, even if the drying condition is not strengthened to D3, the influence of show through on the image quality is minor.

From this, since show through is less likely to occur when the concealment rate is high, the drying condition of the first layer 1802 can be weakened as compared with a case where the concealment rate is low. That is, in the print mode having a high concealment rate, it is possible to increase productivity or suppress power consumption.

Here, the drying conditions of the second layer 1803 and the third layer 1809 will be described.

The image of the third layer 1809 is formed on the second layer 1803. Since the third layer 1809 forms a high definition image, a sufficiently strong condition is applied as the drying condition of the second layer 1803 so that the ink of the image of the third layer 1809 is not immersed in the second layer 1803. Since there is no layer to print on the third layer 1809, there is no need to consider immersion in the third layer 1809. Therefore, a drying condition that satisfies the image quality of the third layer 1809 may be applied.

### Print and Evaluation Method in Present Embodiment

In the present embodiment, using the inkjet print apparatus illustrated in FIG. 1 and using the print head 105 illustrated in FIG. 3, the evaluation image was printed to evaluate the evaluation image.

Next, the evaluation image in the present embodiment will be described. As a print medium, GIY-0305, which is a super PET-based film for window decoration (strong adhesive type) manufactured by LINTEC SIGN SYSTEM, INC, was used. In the evaluation image to be evaluated in the present embodiment, green (50% of Y ink and 50% of C ink) was uniformly printed as a first layer onto a print medium at a design value of the maximum ink application amount of the corresponding print mode, and white ink was uniformly printed as a second layer onto the first layer at a setting value of the corresponding print mode. In each ink, the discharge amount is 4 nanograms (ng) per dot. The reaction liquid was applied to each ink in an amount of 20% of the application amount of each ink.

In the present embodiment, an apparatus used for colorimetry was a fluorescence spectrodensitometer (FD-7: manufactured by Konica Minolta, Inc.).

As a specific evaluation method, in each embodiment, an image was printed under each print condition described later in each print mode, and colorimetry was performed from the side of the print medium and the side of the second layer on the opposite side to acquire chroma C*, and from the viewpoint of whether or not show through can be visually observed, the chroma C* that is less than 15 was determined to be acceptable (◯), and the chroma C* that is 15 or more was determined to be unacceptable (x).

Here, the concealment rate is an index value indicating that the ink film covers the color difference of the lower layer, and a method compliant with ISO 2471 was used as the measurement method of the concealment rate of the present embodiment. As a colorimeter, a spectrophotometer CM-2600d (manufactured by Konica Minolta, Inc.) was used.

### First Embodiment

In the first embodiment, in order to improve the color development of the image of the first layer, a white ink that diffuses and reflects incident light is used as the ink of the concealment layer of the second layer.

The present embodiment includes a plurality of print modes. The print mode includes setting conditions such as a design value I (ng/600 dpi) of the maximum ink application amount of the first layer, a concealment rate of the second layer, and a drying condition of each layer. Furthermore, the present embodiment includes a print mode of the concealment rate of two or more different second layers.

In the present embodiment, a print mode having a higher concealment rate as compared with a print mode having a lower concealment rate weakens the drying condition of the first layer.

Furthermore, in order to satisfy the drying condition, the CPU 401 of the first embodiment controls the drying condition of the first layer at a time T (s) (also called print time) in which the first layer is printed. Therefore, the time T (s) in which the first layer is printed is an example of the drying condition. The time T (s) will be described later.

The CPU 401 controls the time T (s) in which the first layer is printed, which is the drying condition of the first layer, by changing the time from the start of printing of the first layer to the start of printing of the second layer. The drying of the first print layer also proceeds during the printing of the first print layer. Therefore, when the first layer is printed with a certain design amount of ink, the CPU 401 can control the drying condition of the first layer by changing the print time of the first layer. When weakening the drying condition, the CPU 401 shortens the print time of the first layer and shortens the time in which the width of a nozzle row length L is printed. By this, in the first embodiment, productivity can be improved in the print mode having a high concealment rate.

The print apparatus of the present embodiment includes a print mode 1 and a print mode 2 as two print modes. Conditions of the print mode 1 and the print mode 2 are as follows.

### Print Mode 1

Design value I of maximum ink application amount of first layer: 32 ng/600 dpi
Concealment rate of second layer: 60%
Ink amount: 32 ng/600 dpi

### Print Mode 2

Design value I of maximum ink application amount of first layer: 32 ng/600 dpi
Concealment rate of second layer: 80%
Ink amount: 96 ng/600 dpi

Here, dpi is a relative resolution indicating the number of dots per inch. ng is the mass (nanogram) of ink per dot.

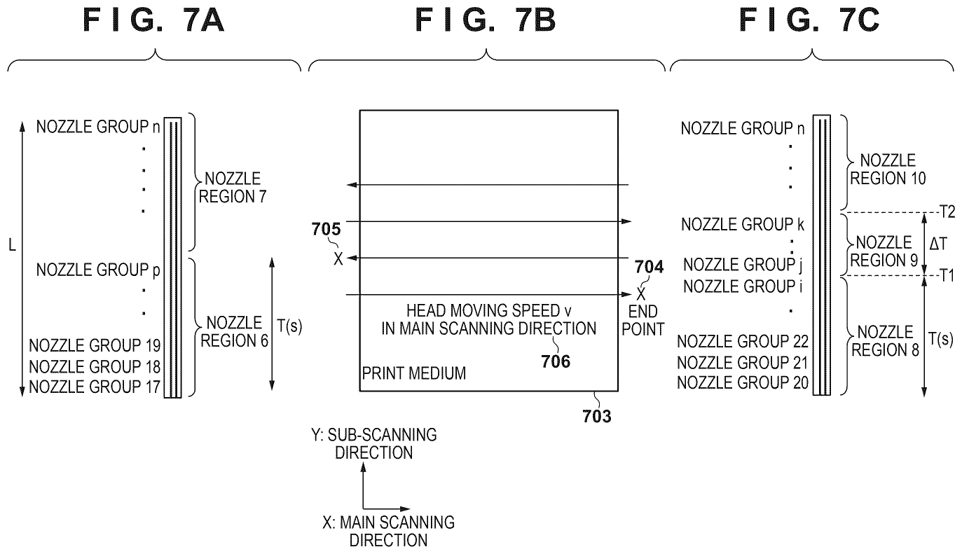

FIGS. 7A to 7C are views describing control of the time T (s) in which the first layer is printed. FIG. 7A is a view describing control of the time T (s) in which the first layer is printed in the first embodiment. As illustrated in FIG. 7A, by changing the number of nozzle groups included in the nozzle region 6 in which the first layer is printed, the CPU 401 changes the number of scans for printing the first layer, and controls the time T (s) in which the first layer is printed. The time T (s) can be obtained by multiplying the time required for one main scan by the number of scans.

Common conditions of other print modes are as follows. The air blowing temperature during printing is 35° C. The air blowing speed is 3 m/s. A moving time MT in the main scanning direction of the print head is 2 seconds per scan. Time Twait is 0 seconds. The waiting time Twait is a time during which the print head waits at a position when the print head is positioned at the end portion of the main scan after finishing one main scan.

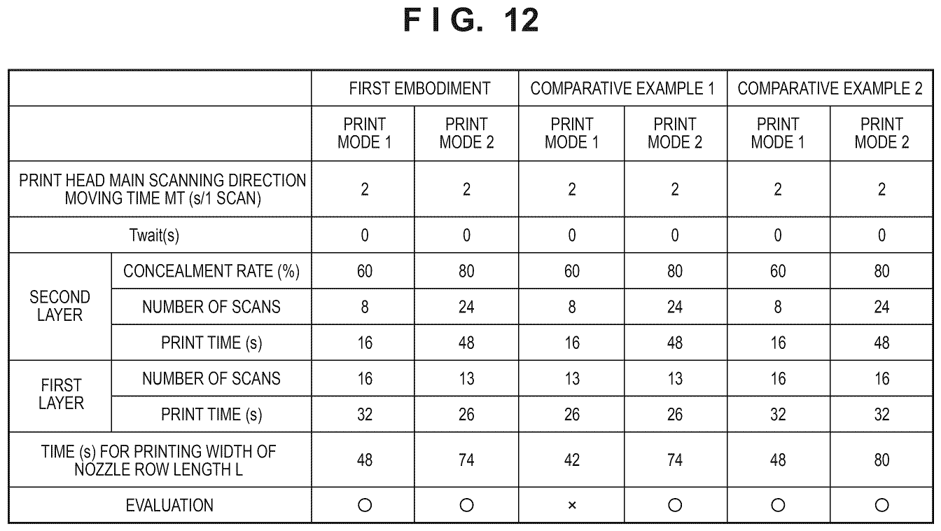

FIG. 12 is a table showing print conditions of print modes of the first embodiment, Comparative Example 1, and Comparative Example 2. In each of the first embodiment, Comparative Example 1, and Comparative Example 2, the print mode 1 and the print mode 2 in which the number of scans of the first layer was changed were set.

In the first embodiment, the number of scans of the first layer in the print mode 1 having a low concealment rate was set to 16, and the number of scans in the print mode 2 having a high concealment rate was set to 13. In this manner, in the first embodiment, the number of scans of the first layer in the print mode 2 is set to be smaller than the number of scans in the print mode 1. Here, as described with reference to FIGS. 11A to 11G, the concealment layer in the print mode 2 is thick, and the concealment rate is high. By this, in the print mode 2, even if the number of scans of the first layer is reduced and the ink of the second layer tends to be immersed in the first layer, show through is less likely to be seen, and deterioration in image quality is small.

In Comparative Example 1, in order to increase productivity, the number of scans of the first layer was set to 13 in both print modes of the print mode 1 and the print mode 2. However, when the concealment rate is 60% as in the print mode 1, the evaluation is a failure. As described with reference to FIGS. 11A to 11G, it is considered to be because the concealment layer that is the second layer is thin, and therefore show through is easily visible.

In Comparative Example 2, the number of scans of the first layer was set to 16 in both print modes of the print mode 1 and the print mode 2 based on a known idea. Although the evaluation is a pass, since in the print mode 2 having a high concealment rate, the number of scans of the first layer is set to 16, it takes 80 seconds to print the width of the nozzle row length L, and the productivity is lowered.

On the other hand, in the first embodiment, by reducing the number of scans of the first layer in the print mode 2 compared to the number of scans of the first layer in the print mode 1, a print time T (s) of the first layer in the print mode 2 is shortened (here, 26 seconds) and the time in which the width of the nozzle row length L is printed is shortened to 74 seconds.

In this manner, in the present embodiment, the number of scans (=13) for printing the first layer in the print mode 2 where the concealment rate is high and the influence of the show through phenomenon is minor is reduced as compared with the number of scans (=16) in the print mode 1 having a low concealment rate. This enables the present embodiment to shorten the print time of the first layer in the print mode 2 as compared with the print mode 1, and shorten the time in which the width of the nozzle row length L is printed. In other words, in the present embodiment, the drying conditions (here, the number of scans and the print time of the first layer) are varied depending on the concealment rate of the print mode. That is, in the present embodiment, even if the print time T (s) of the first layer in the print mode 2 is shortened and the drying condition is weakened, the print mode 2 having a high concealment rate is less likely to have shown through, and therefore it is possible to improve productivity by shortening the time in which the width of the nozzle row length L is printed while suppressing deterioration in image quality.

### Second Embodiment

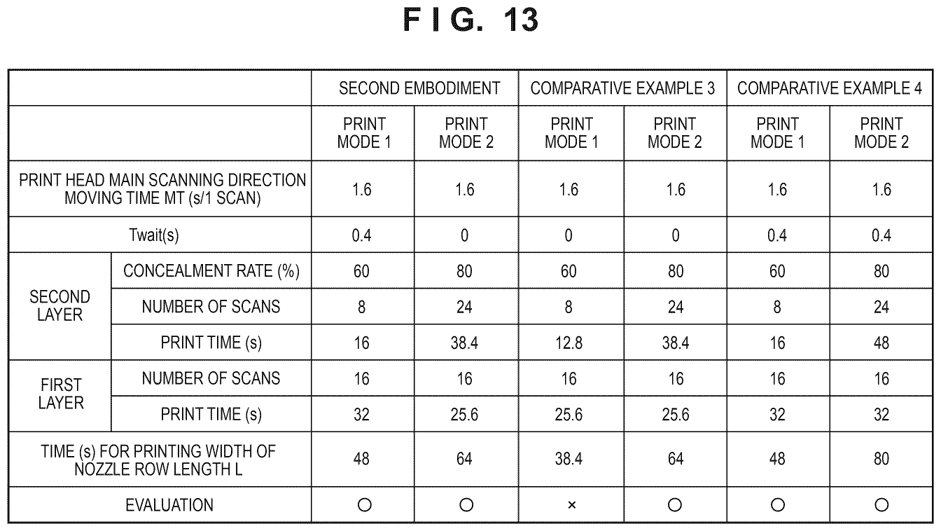

By changing the waiting time (hereinafter, the waiting time Twait), the CPU 401 of the second embodiment controls the print time T (s) of the first layer, and controls the time in which the width of the nozzle row length L is printed. FIG. 7B is a view describing control of the time T (s) in which the first layer is printed in the second embodiment. As illustrated in FIG. 7B, the waiting time Twait is a time during which the print head that scans on a print medium 703 waits at end points 704 and 705, which are the end portions of a reciprocal scan after one main scanning 706. FIG. 13 is a table showing print conditions of print modes of the second embodiment, Comparative Example 3, and Comparative Example 4.

Common conditions of each print mode are as follows. The air blowing temperature during printing is 35° C. The air blowing speed is 3 m/s. As the moving time MT and the number of scans in the main scanning direction of the print head of each layer, the conditions shown in FIG. 13 are used.

In the present embodiment, the print time T (s) in which the first layer is printed is controlled and the drying condition is controlled by changing the waiting time Twait without changing each condition of the print mode described above. Since the time required for the main scan is a value in which the waiting time Twait is added to 1.6 s per scan that is the moving time MT in the main scanning direction of the print head, the time required for the main scan can be controlled by changing the waiting time Twait.

The print modes of the second embodiment, Comparative Example 3, and Comparative Example 4 are print modes having different waiting times Twait.

In the second embodiment, the waiting time Twait in the print mode 1 having a low concealment rate is set to 0.4 s, and the waiting time Twait of the print mode 2 having a high concealment rate is set to 0 s. That is, the waiting time Twait in the print mode 2 is shorter than the waiting time Twait in the print mode 1. In the print mode 2, since the concealment layer that is the second layer is thick and has a high concealment rate, show through is less likely to be seen even if the immersion tendency of the second layer in the first layer becomes high. Therefore, the print mode 2 can suppress deterioration in image quality even if the waiting time is shortened.

In Comparative Example 3, in order to increase productivity, the waiting time Twait in both print modes of the print mode 1 and the print mode 2 was set to 0 s. In Comparative Example 3, when the concealment rate is 60% as in the print mode 1, the evaluation is a failure. This is considered to be because in Comparative Example 3 in the print mode 1, when the first layer is insufficiently dried, the concealment layer is thin and the concealment rate is low, and therefore show through is easily visible.

In Comparative Example 4, based on the known idea, the waiting time Twait in both print modes of the print mode 1 and the print mode 2 was set to 0.4 s to sufficiently dry the first layer. Although the evaluation is a pass, since in the print mode 2 having a high concealment rate, the time in which the width of the nozzle row length L is printed is 80 seconds, the productivity of Comparative Example 4 is lowered.

On the other hand, in the present embodiment, the time in which the width of the nozzle row length L is printed is shortened to 64 seconds by shortening the waiting time Twait in the print mode 2 having a high concealment rate as compared with the print mode 1.

In this manner, in the present embodiment, the print time of the first layer and the second layer is shortened by shortening the waiting time Twait at the time of printing the first layer and the second layer in the print mode 2 where the concealment rate is high and the influence of the show through phenomenon is minor as compared with the print mode 1 having a low concealment rate. In this manner, in the present embodiment, as compared with Comparative Example 2, even if the drying condition is weakened by shortening the time in which the width of the nozzle row length L is printed in the print mode 2, the concealment rate is high, and therefore it is possible to increase the productivity while suppressing deterioration in image quality.

### Third Embodiment

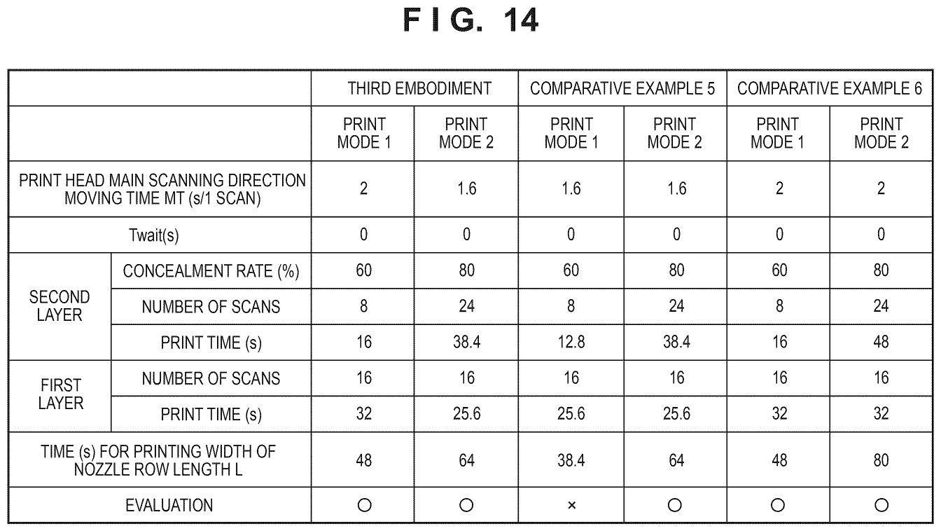

By changing the moving time MT in the main scanning direction of the print head illustrated in FIG. 7B, the CPU 401 of the third embodiment controls the time T (s) in which the first layer is printed, and controls the time in which the width of the nozzle row length L is printed. Note that the CPU 401 may control the moving time MT by controlling the moving speed of the print head. FIG. 14 is a table showing print conditions of print modes of the third embodiment, Comparative Example 5, and Comparative Example 6.

Common conditions of each print mode are as follows. The air blowing temperature during printing is 35° C. The air blowing speed is 3 m/s. As the waiting time Twait and the number of scans of each layer, the conditions shown in FIG. 14 are used.

The print modes of the third embodiment, Comparative Example 5, and Comparative Example 6 have different moving times MT in the main scanning direction of the print head.

In the third embodiment, the moving time MT in the print mode 1 having a low concealment rate is set to 2 s/scan. The moving time MT in the print mode 2 having a high concealment rate is set to 1.6 s/scan. Since the print mode 2 has a thick concealment layer and a high concealment rate, show through is less likely to be seen even if the immersion tendency of the second layer in the first layer becomes high. Therefore, the print mode 2 can suppress deterioration in image quality even if the moving time MT is shortened.

In Comparative Example 5, in order to increase productivity, the moving time MT in both print modes of the print mode 1 and the print mode 2 was set to 1.6 s/scan. In Comparative Example 5, when the concealment rate is 60% as in the print mode 1, the evaluation is a failure. This is considered to be because in Comparative Example 5 in the print mode 1, when the first layer is insufficiently dried, the concealment layer is thin and the concealment rate is low, and therefore show through is easily visible.

In Comparative Example 6, based on the known idea, the moving time MT in both print modes of the print mode 1 and the print mode 2 was set to 2 s/scan to sufficiently dry the first layer. Although the evaluation of Comparative Example 6 is a pass, since in the print mode 2 having a high concealment rate, the time in which the width of the nozzle row length L is printed is 80 seconds, the productivity of Comparative Example 6 is lowered.

According to the present embodiment, the time in which the width of the nozzle row length L is printed is shortened to 64 seconds by shortening the moving time MT in the print mode 2 having a high concealment rate as compared with the print mode 1.

In this manner, in the present embodiment, the print time T (s) in which the first layer and the second layer are printed is shortened by speeding up the moving time MT in the main scanning direction of the print head at the time of printing the first layer and the second layer in the print mode 2 where the influence of the show through phenomenon is minor and the concealment rate is high as compared with the print mode 1 having a low concealment rate. In this manner, in the present embodiment, as compared with Comparative Example 4, even if the drying condition is weakened by shortening the time in which the width of the nozzle row length L is printed in the print mode 2, the concealment rate is high, and therefore it is possible to increase the productivity while suppressing deterioration in image quality.

### Fourth Embodiment

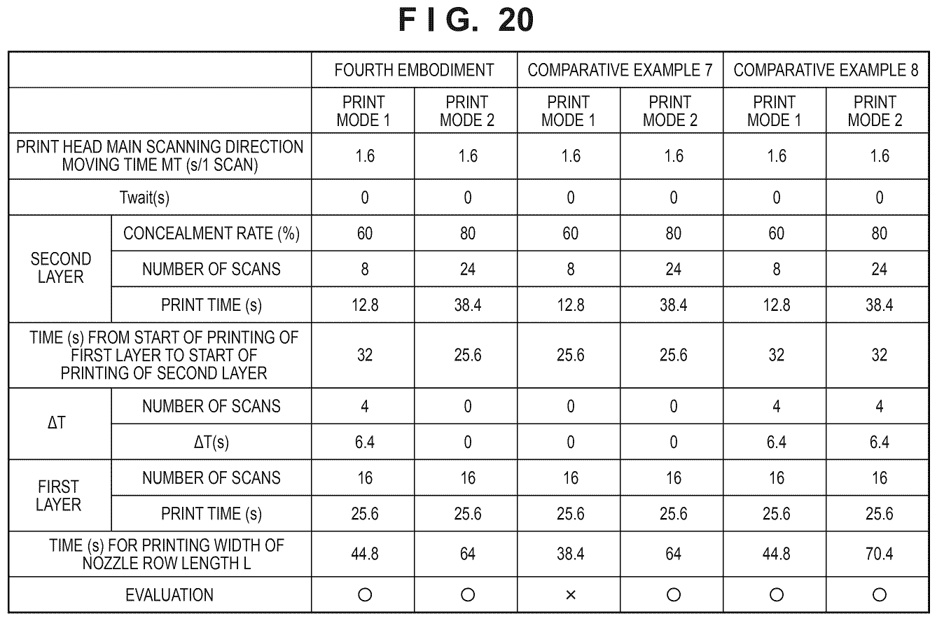

The CPU 401 of the fourth embodiment controls the drying condition of the first layer by changing the time from the end of printing of the first layer to the start of printing of the second layer. When the print end time of the first layer is a time T1 and the print start time of the second layer is a time T2, the CPU 401 of the present embodiment provides a non-print time ΔT during which printing is not performed between time T1 and time T2, and controls the drying condition by the length of the non-print time ΔT. Note that the print time of the first layer is a period of time from the print start time of the first layer to the print start time of the second layer, and may include the non-print time AT. FIG. 20 is a table showing print conditions of print modes of the fourth embodiment, Comparative Example 7, and Comparative Example 8.

As illustrated in FIG. 7C, the nozzle row is divided into nozzle groups from a nozzle group 20 to a nozzle group n, and the nozzle group is further divided into three regions of a nozzle region 8, a nozzle region 9, and a nozzle region 10. The first layer is printed in the nozzle region 8, no ink is discharged in the nozzle region 9, and the second layer is printed in the nozzle region 10. Here, the non-print time ΔT is controlled by changing the number of nozzle groups j to k, which is the number of nozzle groups in the nozzle region 9, that is, the number of scans.

Common conditions of each print mode are as follows. The air blowing temperature during printing is 35° C. The air blowing speed is 3 m/s. The moving time MT in the main scanning direction of the print head is 1.6 seconds/scan. The waiting time Twait is 0 seconds.

The print modes of the fourth embodiment, Comparative Example 7, and Comparative Example 8 have different numbers of scans in the non-print time ΔT between the first layer and the second layer. Note that since the moving time MT per scan is the same, as a result, print modes of the fourth embodiment, Comparative Example 7, and Comparative Example 8 can be said to be different in the non-print times AT.

In the fourth embodiment, the number of scans in the non-print time ΔT in the print mode 1 having a low concealment rate is set to 4, and the number of scans in the non-print time ΔT in the print mode 2 having a high concealment rate is set to 0. That is, the number of scans in the non-print time ΔT in the print mode 2 is smaller than the number of scans in the print mode 1. In the print mode 2, since the number of scans in the non-print time ΔT is small, the non-print time ΔT is shortened, the time (s) from the start of printing of the first layer to the start of printing of the second layer is shortened, and the drying condition is weakened. Since the print mode 2 has a thick concealment layer and a high concealment rate, show through is less likely to be seen even if the immersion tendency of the second layer in the first layer becomes high, and therefore deterioration in image quality can be suppressed.

In Comparative Example 7, in order to increase productivity, the number of scans in the non-print time ΔT in both print modes of the print mode 1 and the print mode 2 was set to 0. In Comparative Example 7, when the concealment rate is 60% as in the print mode 1, the evaluation is a failure. This is considered to be because in Comparative Example 7 in the print mode 1, the concealment layer is thin and the concealment rate is low, and therefore show through is easily visible.

In Comparative Example 8, based on the known idea, the number of scans in the non-print time ΔT in both print modes of the print mode 1 and the print mode 2 was set to 4 to sufficiently dry the first layer. Although the evaluation of Comparative Example 8 is a pass, since in the print mode 2 having a high concealment rate, the time in which the width of the nozzle row length L is printed is 70.4 seconds, the productivity of Comparative Example 8 is lowered.

On the other hand, in the present embodiment, the time in which the width of the nozzle row length L is printed is shortened to 64 seconds by reducing the number of scans in the non-print time ΔT in the print mode 2 having a high concealment rate as compared with the print mode 1 to shorten the non-print time ΔT.

In this manner, in the present embodiment, the non-print time ΔT is shortened by reducing the number of scans in the non-print time ΔT between the print end time T1 of the first layer and the print start time T2 of the second layer in the print mode 2 where the concealment rate is high and the influence of the show through phenomenon is minor as compared with the print mode 1 having a low concealment rate. By this, in the present embodiment, the print time of the first layer is shortened. In this manner, in the present embodiment, as compared with Comparative Example 8, even if the drying condition is weakened by shortening the non-print time ΔT in the print mode 2, the concealment rate is high, and therefore it is possible to increase the productivity while suppressing deterioration in image quality.

### Fifth Embodiment

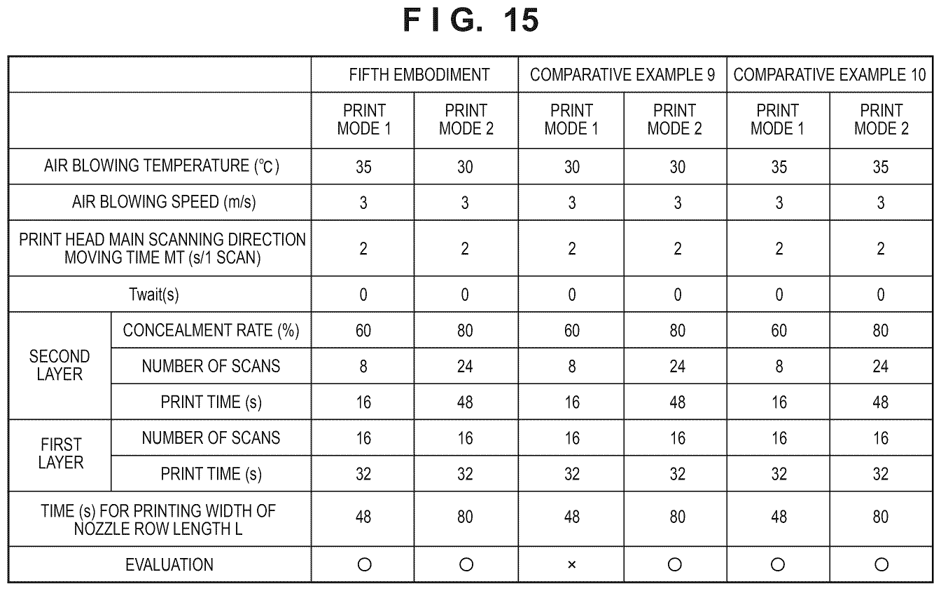

In order to control the drying conditions, the CPU 401 of the fifth embodiment controls the heater 210 of the platen air blowing unit 206 illustrated in FIG. 2 when printing the first layer, thereby controlling the air blowing temperature that is the temperature of the air blown by the fan 211. FIG. 15 is a table showing print conditions of print modes of the fifth embodiment, Comparative Example 9, and Comparative Example 10.

Common conditions of each print mode are as follows. The air blowing speed is 3 m/s. As the moving time MT, the waiting time Twait, and the number of scans of each layer, the conditions shown in FIG. 15 are used.

The print modes of the fifth embodiment, Comparative Example 9, and Comparative Example 10 have different air blowing temperatures.

In the fifth embodiment, the air blowing temperature in the print mode 1 having a low concealment rate is set to 35° C., and the air blowing temperature in the print mode 2 having a high concealment rate is set to 30° C. In the print mode 2, since the concealment layer is thick and the concealment rate is high, show through is less likely to be seen even if the immersion tendency of the second layer in the first layer becomes high. Therefore, in the print mode 2, even if the air blowing temperature is lowered, it is possible to suppress power consumption while suppressing deterioration of image quality.

In Comparative Example 9, in order to reduce power consumption, the air blowing temperature in both print modes of the print mode 1 and the print mode 2 was set to 30° C. In Comparative Example 9, when the concealment rate is 60% as in the print mode 1, the evaluation is a failure. This is considered to be because in Comparative Example 9 in the print mode 1, when the air blowing temperature is low and the first layer is insufficiently dried, the concealment layer is thin and the concealment rate is low, and therefore show through is easily visible.

In Comparative Example 10, based on the known idea, the air blowing temperature in both print modes of the print mode 1 and the print mode 2 was set to 35° C. to sufficiently dry the first layer. Although the evaluation is a pass in Comparative Example 10, since the air blowing temperature is raised, the power consumption in the print mode 2 having a high concealment rate increases.

On the other hand, in the present embodiment, the power consumption is reduced by lowering the air blowing temperature in the print mode 2 having a high concealment rate as compared with the print mode 1.

In this manner, in the present embodiment, the air blowing temperature at the time of printing the first layer and a print start time T2 of the second layer in the print mode 2 where the concealment rate is high and the influence of the show through phenomenon is minor as compared with the print mode 1 having a low concealment rate. In this manner, in the present embodiment, even if the air blowing temperature in the print mode 2 is lowered to weaken the drying condition, the concealment rate in the print mode 2 is high, and therefore it is possible to suppress power consumption while suppressing deterioration in image quality.

### Sixth Embodiment

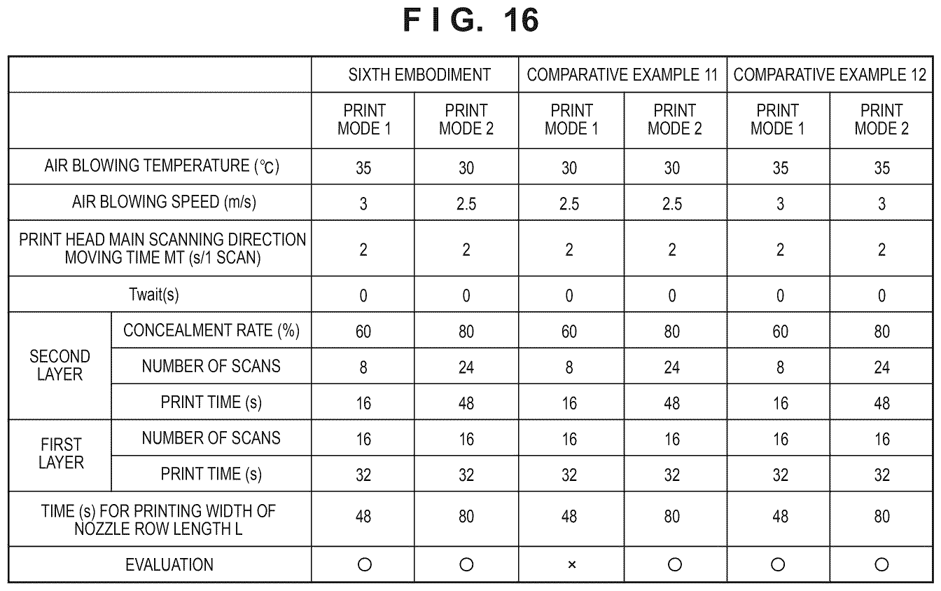

In order to control the drying conditions, the CPU 401 of the sixth embodiment controls the air blowing speed that is the speed of the air blown by the fan 211 of the platen air blowing unit 206 illustrated in FIG. 2 when printing the first layer. FIG. 16 is a table showing print conditions of print modes of the sixth embodiment, Comparative Example 11, and Comparative Example 12.

Common conditions of each print mode are as follows. The air blowing temperature is 35° C. As the moving time MT, the waiting time Twait, and the number of scans of each layer, the conditions shown in FIG. 16 are used.

The print modes of the sixth embodiment, Comparative Example 11, and Comparative Example 12 have different air blowing speeds.

In the sixth embodiment, the air blowing speed in the print mode 1 having a low concealment rate is set to 3 m/s, and the air blowing speed in the print mode 2 having a high concealment rate is set to 2.5 m/s. That is, the air blowing speed in the print mode 2 is lower than the air blowing speed in the print mode 1. Since the print mode 2 has a thick concealment layer and a high concealment rate, show through is less likely to be seen even if the immersion tendency of the second layer in the first layer becomes high. Therefore, the print mode 2 can suppress deterioration in image quality even if the air blowing speed is slowed.

In Comparative Example 11, in order to reduce power consumption, the air blowing speed in both print modes of the print mode 1 and the print mode 2 was set to 2.5 m/s. In Comparative Example 11, when the concealment rate is 60% as in the print mode 1, the evaluation is a failure. This is considered to be because in Comparative Example 11 in the print mode 1, when the air blowing speed is slow and the first layer is not sufficiently dried, the concealment layer is thin and the concealment rate is low, and therefore show through is easily visible.

In Comparative Example 12, based on the known idea, the air blowing speed in both print modes of the print mode 1 and the print mode 2 was set to 3 m/s to sufficiently dry the first layer. Although the evaluation is a pass, since in the print mode 2 having a high concealment rate, the air blowing speed is sped up, the power consumption increases.

In this manner, in the present embodiment, the air blowing speed at the time of drying the first layer is slowed down in the print mode 2 where the influence of the show through phenomenon is minor and the concealment rate is high as compared with the print mode 1 having a low concealment rate. By this, in the present embodiment, even if the drying condition of the print mode 2 is weakened, the concealment rate is high, and therefore it is possible to suppress power consumption while suppressing deterioration of image quality.

### Seventh Embodiment

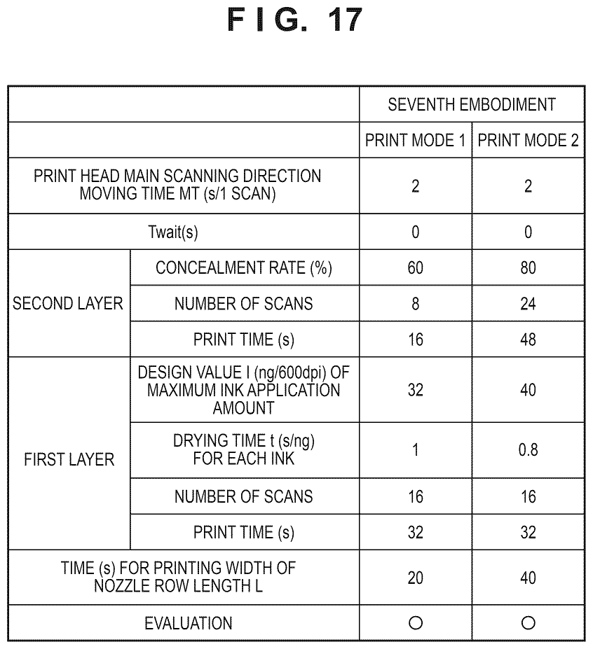

The CPU 401 of the seventh embodiment controls the drying condition by controlling the design value of the maximum application amount of the image ink of the first layer and the drying time per unit ink. FIG. 17 is a table showing print conditions of print modes of the seventh embodiment.

In the present embodiment, the concept of a drying time t (s/ng) per unit ink of the first layer is introduced. Even if the design value I (ng/600 dpi\hat{ }2) of the maximum ink application amount of the first layer is different, when the drying time t (s/ng) per unit ink is the same, the dry state of the first layer is the same, and the immersion amount in the first layer by the second layer is the same.

The time T (s) in which the ink layer of the image of the first layer is formed is obtained by the following expression.

$$T ( s ) = t ( s / ng ) \times I ( ng / 600 dpi \hat{} 2 )$$

The CPU 401 sets the drying time t (s/ng) per unit ink of the first layer to the same value for the print mode in which the concealment rate of the second layer is the same.

Furthermore, the CPU 401 sets the drying time t (s/ng) per unit ink of the first layer in the print mode 2 having a high concealment rate to be shorter than that in the print mode 1 in which the concealment rate of the second layer is low.

The present embodiment includes the print mode 1 and the print mode 2. In the print mode 1 and the print mode 2, the concealment rate and the design value I (ng/600 dpi\hat{ }2) of the maximum ink application amount of the first layer are different.

A similar evaluation to that of the previous embodiments was performed, and it was determined whether or not to pass.

As shown in FIG. 17, in the print mode 1 having a low concealment rate, the drying time t (s/ng) per unit ink of the first layer was set to 1. In the print mode 2 having a high concealment rate, the drying time t (s/ng) per unit ink of the first layer was set to 0.8. Therefore, in the print mode 2, the drying condition is weaker than that in the print mode 1. Furthermore, while the drying time of the first layer is accidentally the same time of 32 seconds in the print mode 1 and 32 seconds in the print mode 2, since the drying time t (s/ng) per unit ink of the first layer is small, the drying condition is weaker in the print mode 2. However, both the print mode 1 and the print mode 2 of the seventh embodiment are evaluated as a pass. In this manner, in the present embodiment, even if the drying condition in the print mode 2 is weakened, since the concealment layer of the second layer in the print mode 2 is thick and the concealment rate is high, it is possible to reduce power consumption required for drying while suppressing deterioration in image quality.

### Eighth Embodiment

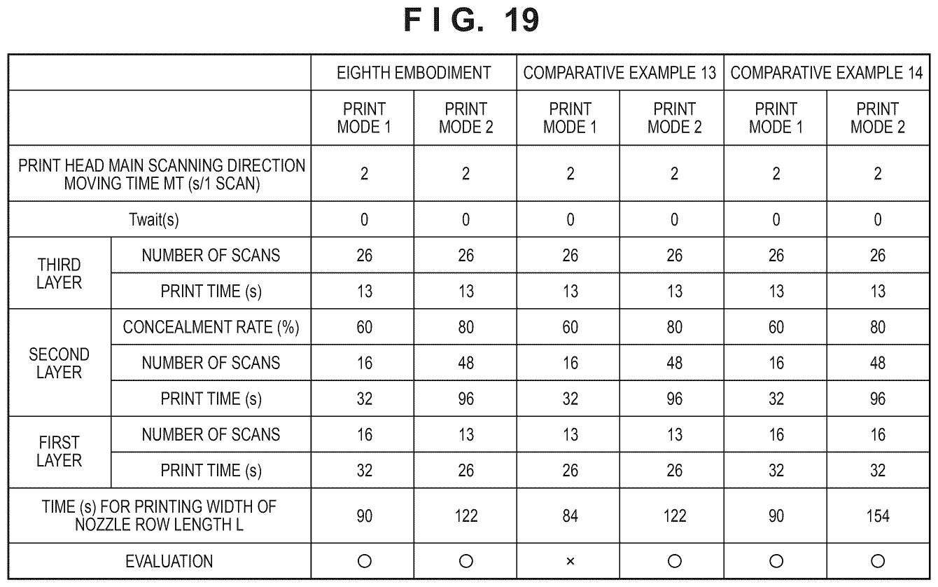

The CPU 401 of the eighth embodiment controls the print time T (s) of the first layer by changing the number of scans for printing the first layer in the SW3 configuration. FIG. 19 is a table showing print conditions of print modes of the eighth embodiment, Comparative Example 13, and Comparative Example 14.

The print apparatus of the present embodiment includes the print mode 1 and the print mode 2 as two print modes. Conditions of the print mode 1 and the print mode 2 are as follows.

### Print Mode 1

Design value I of maximum ink application amount of first layer: 32 ng/600 dpi
Concealment rate of second layer: 60%
Ink amount: 32 ng/600 dpi
Design value I of maximum ink application amount of third layer: 32 ng/600 dpi

### Print Mode 2

Design value I of maximum ink application amount of first layer: 32 ng/600 dpi
Concealment rate of second layer: 80%
Ink amount: 96 ng/600 dpi
Design value I of maximum ink application amount of third layer: 32 ng/600 dpi

Common conditions of each print mode are as follows. The air blowing temperature during printing is 35° C. The air blowing speed is 3 m/s. As the moving time MT and the waiting time Twait of the print head of each layer, the conditions shown in FIG. 19 are used.

By changing the number of scans of printing of the first layer, the CPU 401 of the present embodiment controls the print time T (s) of the first layer and controls the drying condition. As described with reference to FIG. 5D, in the present embodiment, by changing the number of nozzle groups in the nozzle region 3, the print time T (s) of the first layer is controlled, and the drying condition is controlled.

The print modes of the eighth embodiment, Comparative Example 13, and Comparative Example 14 have different numbers of scans of the first layer.

The CPU 401 of the present embodiment sets the number of scans of the first layer in the print mode 1 in which the concealment rate of the second layer is low to 16. The CPU 401 sets the number of scans of the first layer in the print mode 2 having a high concealment rate to 13. That is, the number of scans in the print mode 2 is smaller than the number of scans in the print mode 1. As described with reference to FIGS. 18A to 18G, in the print mode 2, since the concealment layer is thick and the concealment rate is high, show through is less likely to be seen even if the immersion tendency of the second layer in the first layer becomes high. Therefore, the print mode 2 can suppress deterioration in image quality even if the number of scans of the first layer is reduced to shorten the first print time T (s).

In Comparative Example 13, in order to increase productivity, the number of scans in both print modes of the print mode 1 and the print mode 2 was set to 13. In Comparative Example 13, when the concealment rate is 60% as in the print mode 1, the evaluation is a failure. As described with reference to FIGS. 18A to 18G, it is considered that in the print mode 1 of Comparative Example 13, when the number of scans is reduced and the first layer is not sufficiently dried, the concealment layer is thin and the concealment rate is low, and therefore show through is easily visible.

In Comparative Example 14, based on the known idea, the number of scans in both print modes of the print mode 1 and the print mode 2 was set to 16 to sufficiently dry the first layer. Although the evaluation is a pass, since in the print mode 2 having a high concealment rate, the time in which the width of the nozzle row length L is printed is 154 seconds, the productivity of Comparative Example 14 is lowered.

In Comparative Example 14 based on the known idea, the time in which the width of the nozzle row length L is printed in the print mode 2 having a high concealment rate is 154 seconds. On the other hand, in the present embodiment, the time in which the width of the nozzle row length L is printed in the print mode 2 having a high concealment rate can be set to 112 seconds, which is shorter than that in Comparative Example 14.

In this manner, in the present embodiment, the time T (s) in which the first layer is printed can be shortened, the drying condition can be weakened, and the productivity can be increased by reducing the number of scans for printing the first layer of the print mode 2 where the influence of the show through phenomenon is minor and the concealment rate is high as compared with the print mode 1 having a low concealment rate.

In the present embodiment, the method of controlling the drying condition by controlling the number of scans for printing the first layer is used in the SW3 configuration, but the drying condition may be controlled by changing at least any of the waiting time Twait, the moving time MT, the non-print time ΔT, the air blowing temperature, and the air blowing speed, similarly to the OF configuration. Furthermore, these may be controlled simultaneously.

### OTHER EMBODIMENTS

In the present embodiment, the drying condition is controlled by independently changing the number of scans for printing the first layer, Twait, v, AT, the air blowing temperature, and the air blowing speed, but the drying condition may be controlled by simultaneously changing two or more conditions of the number of scans for printing the first layer, the waiting time Twait, the moving time MT, the non-print time ΔT, the air blowing temperature, and the air blowing speed.

The above-described embodiments may be combined. In this case, the main control unit 400 may combine the print condition and the drying condition based on an input from the user, or may combine them based on a predetermined condition.

According to the present disclosure, the first layer can be appropriately dried.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-156833, filed Sep. 10, 2024, which is hereby incorporated by reference herein in its entirety.

What is claimed is:

1. A print apparatus comprising:
a print unit that applies ink to a transparent print medium;
a drying unit that dries a print medium to which ink is applied by the print unit; and
a control unit that controls the print unit and the drying unit, wherein
the control unit
causes the print unit to print a first layer, causes the drying unit to dry the transparent print medium on which the first layer is printed, and causes the print unit to print a second layer that conceals the first layer on the first layer after the first layer has dried,
controls printing of the first layer and the second layer based on one print mode determined from among a plurality of print modes including a first print mode and a second print mode in which a concealment rate of the second layer is different from a concealment rate of the first print mode, and
controls drying of the first layer based on a drying condition in accordance with the concealment rate of the determined print mode.

2. The print apparatus according to claim 1, wherein
the control unit controls printing of a third layer based on a print mode including a setting of the third layer to be printed on the second layer.

3. The print apparatus according to claim 1, wherein
the control unit controls drying of the first layer based on the drying condition including a print time, which is a time for printing the first layer varying depending on the concealment rate.

4. The print apparatus according to claim 3, wherein
the control unit controls the print time by a number of scans of a print head that prints the first layer.

5. The print apparatus according to claim 3, wherein
the control unit controls the print time by a waiting time at an end portion in a reciprocal scan of a print head that prints the first layer.

6. The print apparatus according to claim 3, wherein
the control unit controls the print time by a moving time per scan of a print head that prints the first layer.

7. The print apparatus according to claim 1, wherein
the control unit
defines, as a non-print time, a period of time in which printing is not performed between a time at which printing of the first layer ends and a time at which printing of the second layer is started, and controls drying of the first layer based on the drying condition including the non-print time varying depending on the concealment rate.

8. The print apparatus according to claim 1 comprising:
an air blowing unit that blows hot air to dry the first layer, wherein
the control unit controls drying of the first layer based on the drying condition including a temperature of the hot air varying depending on the concealment rate.

9. The print apparatus according to claim 1 comprising:
an air blowing unit that blows air to dry the first layer, wherein
the control unit controls drying of the first layer based on the drying condition including a speed of the blowing varying depending on the concealment rate.

10. The print apparatus according to claim 1, wherein
the control unit controls drying of the first layer based on the drying condition including a drying time per unit ink of the first layer varying depending on the concealment rate.

11. The print apparatus according to claim 1, wherein
the second print mode is higher in the concealment rate and weaker in the drying condition than the first print mode.

12. A control method comprising:
printing by applying ink to a transparent print medium;
drying a print medium to which ink is applied; and
controlling a print unit and a drying unit, wherein
the controlling comprises
controlling printing a first layer, drying the transparent print medium on which the first layer is printed, and printing a second layer that conceals the first layer on the first layer after the first layer has dried,
controlling printing of the first layer and the second layer based on one print mode determined from among a plurality of print modes including a first print mode and a second print mode in which a concealment rate of the second layer is different from a concealment rate of the first print mode, and
controlling drying of the first layer based on a drying condition in accordance with the concealment rate of the determined print mode.

13. A non-transitory computer-readable storage medium storing a computer program for causing, when read and executed by a computer, the computer to:
control printing by applying ink to a transparent print medium, and drying a print medium to which ink is applied; wherein
the computer program causes the computer to:
control printing a first layer, drying the transparent print medium on which the first layer is printed, and printing a second layer that conceals the first layer on the first layer after the first layer has dried,
control printing of the first layer and the second layer based on one print mode determined from among a plurality of print modes including a first print mode and a second print mode in which a concealment rate of the second layer is different from a concealment rate of the first print mode, and
control drying of the first layer based on a drying condition in accordance with the concealment rate of the determined print mode.
